(19) United States
(12) Patent Application Publication
(10) Pub. No.: US 2007/0155926 A1
(43) Pub. Date: Jul. 5, 2007

(54) Degradable polymers

(76) Inventors: Krzysztof Matyjaszewski, Pittsburgh, PA (US); Im Sik Chung, Daejeon (KR); Jinyu Huang, Pittsburg, PA (US); Traian Sarbu, Pittsburg, PA (US); Daniel L. Siegwart, Pittsburgh, PA (US); James Spanswick, Wheaton, IL (US); Nicolay V. Tsarevsky, Pittsburgh, PA (US)

Correspondence Address: KIRKPATRICK & LOCKHART PRESTON GATES ELLIS LLP, 535 SMITHFIELD STREET, PITTSBURGH, PA, 15222, US

(21) Appl. No.: 10/548,354

(22) PCT Filed: Mar. 29, 2004
(86) PCT No.: PCT/US04/09905

§ 371 Date: Nov. 17, 2006

Related U.S. Application Data
(60) Provisional application No. 60/458,784, filed on Mar. 28, 2003.

(51) Int. Cl. C08F 120/00

(52) U.S. Cl. 526/303.1; 526/319; 526/346

(57) ABSTRACT

Polymers comprising a polymer backbone comprising one or more degradable units are described. The polymer may additionally comprise two or more polymer segments comprising radically (co)polymerizable vinyl monomer units. The degradable units may be independently selected from, but not limited to, at least one of hydrodegradable, photodegradable and biodegradable units between the polymer segments and dispersed along the polymer backbone. The degradable units may be derived from one or more monomers comprising a heterocyclic ring that is capable of undergoing radical ring opening polymerization, a coupling agent, or from a polymerization initiator, radically polymerizable monomers, as well as other reactive sources. Embodiments of the degradable polymer of claim are capable of degrading by at least one of a hydrodegradation, photodegradation or biodegradation mechanisms to form at least one of telechelic oligomer and telechelic polymeric fragments of the polymer. The degradable polymer may be able to degrade into polymer fragments having a molecular weight distribution of less than 5, or in certain applications it may be preferable for embodiments of the polymer to be capable of forming polymer fragments having a molecular weight distribution of the polymer fragments less than 3.0 or even less than 2.5. Embodiments of the present invention also include methods of producing degradable polymers.

### TECHNICAL FIELD OF THE INVENTION

Degradable vinyl based polymers are prepared by controlled polymerization techniques. The polymers may comprise various functional groups the provide photo-degradability, hydro-degradability, and/or biodegradability. The functional groups may be any photo-degradable, hydro-degradable, and/or biodegradable functional group including, but not limited to, ester, ether, ketone, carbonate, amide, carbamate, anhydride or corresponding sulfur based functional groups. The functional groups may be dispersed along a polymer backbone or located at junctures in a branched or network polymer system.

The functional groups can be incorporated into the copolymer in a regular manner by the addition of unsaturated heterocyclic monomers, that (co)polymerize via a radical ring polymerization process, to the polymerization of radically (co)polymerizable olefinic or vinyl monomers, by the use functional initiators or functional coupling molecules in a coupling or chain extension process, through the use of AB* monomers additionally comprising the functional degradable unit, or through the use of difunctional molecules additionally possessing the degradable functional group in a copolymerization. The polymers can be degraded by hydrolysis, photolysis or by biodegradation in an external environment or within a living body to form fragments of the original polymer.

### DESCRIPTION OF EMBODIMENTS OF THE INVENTION

Free radical ring-opening polymerization (RROP) has been proposed as a useful route for the synthesis of polymers with various functional groups, such as ether, ketone, ester, amide, and carbamate, in their backbone. [Ivin, K. J.; Saegusa, T. Ring-Opening Polymerization; Elsevier Applied Science: London, 1984; Chapter 1; Bailey, W. J.; Wu. S.-R.; Ni, Z. Macromol. Chem. 1982, 183, 1913; Bailey, W. J. Polym. J. 1985, 17, 85. Hiraguri, Y.; Endo, T. J. Am. Chem. Soc. 1987, 109, 3779; Klemm, E.; Schulze, T. Acta Polym. 1999, 50, 1; Sanda, F.; Endo, T. J. Polym. Sci., Polym. Chem. Ed. 2000, 39, 265.] The latter reference proposes that unsaturated heterocycles including cyclic disulfides, bicyclobutane, vinylcyclopropane, vinylcyclobutane, vinyloxirane, vinylthiirane, 4-methylene-1,3-dioxolane, cyclic ketene acetal, cyclic arylsulfide, cyclic α-oxyacrylate, benzocyclobutene, o-xylylene dimer, exo-methylene-substituted spiro orthocarbonate, exo-methylene-substituted spiro orthoester, and vinylcyclopropanone cyclic acetal can undergo copolymerization with commercial monomers. This is one route to improve some of the properties of the resulting polymers, such as thermal stability, low volume shrinkage during polymerization, and degradability. Indeed, the radical copolymerization of a cyclic ketene acetal with styrene, methyl methacrylate, vinyl acetate, and methyl vinyl ketone affords polymers showing enzymatic degradability and photodegradability. [Bailey, W. J.; Wu, S.-R.; Ni, Z. J. Macromol. Sci., Pure Appl. Chem. 1982, A18, 973; He, P.-S.; Zhou, Z.-Q.; Pan, C.-Y.; Wu, R.-J. J. Mater. Sci. 1989, 24, 1528; Brady, R. F. J. J. Macromol. Sci., Rev. Macromol. Chem. Phys. 1992, C32, 135. Endo, T. Macromolecules 1994, 27, 1099. Bailey, W. J.; Ni, Z.; Wu. S.-R. J. Polym. Sci, Polym. Chem. Ed. 1982, 20, 2420. Fukuda, H.; Hirota, M. J. Polym. Sci., Polym. Chem. Ed. 1982, 20, 2935. Koizumi, T.; Hasegawa, Y.; Takata, T, Endo, T. J. Polym. Sci., Polym. Chem. Ed. 1994, 32, 3193. Hiraguri, Y.; Tokiwa, Y. J. Polym. Sci., Polym. Chem. Ed. 1993, 31, 3159. Hiraguri, Y.; Tokiwa, Y. Macromolecules 1997, 30, 3691.]

However, since conventional radical initiators were used for such radical (co)polymerization reactions the molecular weight of the resulting (co)polymers can not be controlled and molecular weight distributions are quite broad, well above 2.0. The term “polymer” is used to refer to a chemical compound that comprises linked monomers, and that may or may not be linear. Polymer “segments” refer to an oligomers or polymers that are covalently bound to two additional moieties, generally end-capping moieties at each of two termini. Further the copolymers were prepared from monomer mixtures containing 50% of each monomer and resulted in copolymers with 30-40% of the RROP monomer in the backbone. While no investigation was made on the distribution of comonomers along the copolymer backbone in these papers, the difference in composition between the feed ratios and monomer ratios in the copolymer would indicate non-random incorporation. Further, it is known that when there are differences in the reactivity ratios of the comonomers used in a standard free radical polymerization or conventional free radical polymerization, the resulting copolymers display compositional heterogeneity between the polymer chains in the final sample, (see scheme 1), therefore any subsequent degradation reaction will yield a material with a very broad molecular weight distribution (MWD), such as greater than 5.0.

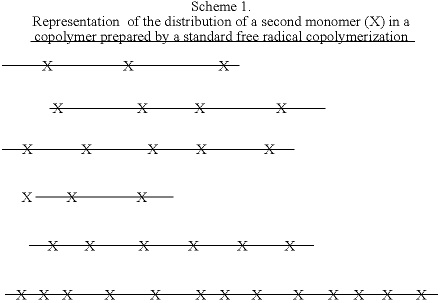

Controlled/“living” radical polymerization processes (CRP) can provide compositionally homogeneous well-defined polymers, with predictable molecular weight, narrow molecular weight distribution, typically less than 2.0, a high degree of end-functionalization and further can provide some control over the distribution of comonomers along a polymer backbone. Since all polymer chains in a CRP are initiated quickly and grow at approximately the same rate and incorporate comonomers at a rate depending not only on reactivity ratio's but also on the instantaneous concentration of the comonomers. In addition the instantaneous concentration of the comonomers may be manipulated by physical means, such as, monomer addition or monomer removal thereby providing an additional tool for controlled distribution of the desired functionality along the copolymer chain. [Matyjaszewski, K., Ed. Controlled Radical Polymerization; ACS: Washington, D.C., 1998; ACS Symposium Series 685. Matyjaszewski, K., Ed. Controlled/Living Radical Polymerization. Progress in ATRP, NMP, and RAFT, ACS: Washington, D.C., 2000; ACS Symposium Series 768. Matyjaszewski, K, Davis, T. P., Eds. Handbook of Radical Polymerization; Wiley: Hoboken, 2002. Qiu, J.; Charleux, B.; Matyjaszewski, K Prog. Polym. Sci. 2001, 26, 2083. Davis, K. A.; Matyjaszewski, K. Adv. Polym. Sci. 2002, 159, 1.] In a batch CRP, any differences in the reactivity ratio's of the (co)monomers is seen as a gradient of composition along each and every polymer chain. Degradation of such a gradient copolymer leads to a polymers with a broad MWD.

Among the various CRP methods, atom transfer radical polymerization (ATRP) is presently the most robust due to its ability to copolymerize a broad range of monomers with various functional groups, its tolerance of solvents of different polarity as well as to impurities often encountered in industrial systems. This polymerization process is particularly suited for the preparation of telechelic polymers suitable for coupling reactions and for the copolymerization of AB* monomers, however other controlled polymerization processes are also suitable for use in the procedures described herein for the preparation of degradable polymers. [Matyjaszewski, K.; Xia, J. Chem. Rev. 2001, 101, 2921. Kamigaito, M.; Ando, T.; Sawamoto, M. Chem. Rev. 2001, 101, 3689. Coessens, V.; Pintauer, T.; Matyjaszewski, K. Prog Polym. Sci. 2001, 26, 337. Patten, T. E.; Matyjaszewski, K. Acc. Chem. Res. 1999, 32, 895. Patten, T. E.; Matyjaszewski, K. Adv. Mater. 1998, 10, 901. Wang, J. S.; Matyjaszewski, K. J. Am. Chem. Soc. 1995, 117, 5614] The process has additionally been thoroughly described in a series of co-assigned U.S. Patents and Applications, U.S. Pat. Nos. 5,763,546; 5,807,937; 5,789,487; 5,945,491; 6,111,022; 6,121,371; 6,124,411; 6,162,882; 6,407,187; 6,538,091 and U.S. patent application Ser. Nos. 09/359,359; 09/359,591; 09/369,157; 09/534,827; 09/972,046; 09/972,056; 09/972,260; 10/034,908; 10/098,052; 10/269,556; 10/271,025; 60/398,443; 60/402,279; 60/417,591 and 60/429,256 all of which are herein incorporated by reference. The definitions included in these cited references will be used in this application in addition to definitions given below.

Suitable living free radical polymerization initiators for use in ATRP polymerization methods may have the structural formula 1.
(R)—Xₙ Formula 1
in which R is a core residue of an initiator molecule, X is a radically transferable atom of group and n is the number of radically transferable atoms or groups attached to R. Each X is capable of end capping the (co)polymerization of vinyl monomers in an ATRP.

Suitable vinyl monomers comprise monomers with alkyl or aryl substituents, including substituted and unsubstituted alkyl and aryl, or monomers wherein the substituents are, for example, cyano, carboxyl, and the like, or where the substituents together form an optionally alkyl-substituted cycloalkyl ring containing 4 to 7, typically 5 or 6, carbon atoms. Suitable substituents are alkyl, alkenyl, aryl, and aryl-substituted alkyl, although preferred substituents comprise halogenated aryl moieties. Examples of specific substituents include phenyl, substituted phenyl (particularly halogenated phenyl such as p-bromophenyl and p-chlorophenyl), benzyl, substituted benzyl (particularly halogenated benzyl and alpha-methyl benzyl), lower alkenyl, particularly allyl, and cyanoisopropyl.

X has been defined in disclosed and incorporated references and includes radically transferable atoms of groups such as halogen, preferably chloro or bromo.

n can be one or greater but for simple coupling reactions described below n is most often one or two. When n is three or greater then branching or cross-linking coupling can occur.

R can comprise any organic, inorganic or hybrid core molecule as described in disclosed and incorporated commonly assigned patents and applications and can comprise functionality directly attached to the core molecule R or incorporated into the core molecule R as a linking group between different segments of R or between fractions of R and X.

There have been several reports on controlled free radical ring-opening homo-polymerization (RROP) of certain cyclic ketene acetals (Chart 1, structures a-d). One group used TEMPO (2,2,6,6-tetramethyl-1-piperidinyloxy radical) as the controlled radical polymerization mediator. [Wei, Y.; Connors, E. J.; Jia, X.; Wang, B. Chem. Mater. 1996, 8, 604; and Wei, Y.; Connors, E. J.; Jia, X.; Wang, C. J. Polym. Sci., Polym. Chem. Ed. 1998, 36, 761.] Another group employed ATRP. [Pan, C.-Y. Lou, X.-D. Macromol. Chem. Phys. 2000, 201, 1115; Yuan, J.-Y.; Pan, C.-Y.; Tang, B. Z. Macromolecules 2001, 34, 211; Yuan, J.-Y.; Pan, C.-Y.; Eur. Polym. J. 2002, 38, 1565] The materials prepared in these controlled RROP's were homopolymers, chain extended block polymers or copolymers with high levels of the RROP monomer. The cyclic ketene acetals used in these polymerizations are relatively unreactive monomers and their copolymerization with conventional vinyl monomers is difficult, particularly with a reactive monomer such as methyl methacrylate (MMA). Low levels of the cyclic ketene acetal would not be uniformly incorporated into the copolymer under standard polymerization conditions. Indeed the only series of—“random” copolymers previously reported was work discussed by Yuan, J.-Y.; Pan, C.-Y.; Eur. Polym. J. 2002, 38, 2069, who selected 4,7-dimethyl-2-methylene-1,3-dioxepane (DMMDO) (Chart 1, structure b) as the monomer that underwent RROP to investigate its copolymerization with styrene (St), acrylonitrile (AN) and methyl acrylate (MA), using ATRP. They concluded that the polymerization of DMMDO involves two different reactive chain radicals; and noted that when the 1,3-dioxepane ring of DMMDO undergoes ring opening polymerization the ring is opened to form a secondary radical H2COOCH(CH3)CH2CH2(CH3)CH*, thus the simple addition unit radical is more stable than the ring-opened unit radical, leading to the possibility of an increase in termination reactions. Further they concluded that while DMMDO and commercial monomers, St, AN and MA do undergo controlled copolymerizations by ATRP they noted that with an electron-donor monomer such as St, the copolymerization of St with DMMDO yields a copolymer with a small amount of DMMDO units incorporated into the copolymer, because of much higher reactivity of St than that of DMMDO. When they increased the feed ratio of DMMDO the polymerization rate became even slower and the molecular weight of the resulting copolymers decreased. A different situation arose in the copolymerization of electron-acceptor monomers AN and MA with DMMDO, these copolymers contain higher levels of DMMDO in both ring-opened and addition units, however the molar ratios of DMMDO to MA or AN in the copolymers did not change very much despite varying the molar ratios of DMMDO in the monomer feed from 30:70 to 70:30, probably due to the existence of a donor/acceptor interaction between MA or AN and DMMDO, i.e. alternating copolymers were prepared. Therefore neither copolymerization of DMMDO with electron donor monomers or electron acceptor monomers teaches a route to prepare copolymers with a controlled distribution of the RROP monomer units along the polymer backbone.

Low reactivity of the cyclic ketene acetal in copolymerization reactions may be due to the presence of two electron donating substituents which can not stabilize the resulting radical. We considered that it would be interesting to replace one of the groups in the cyclic ketene acetal ring (Chart 1 structure b) with an electron withdrawing group such as a carbonyl group and generate a captodative system (Chart 1 structure e). [Pasto, D. E. J. Am. Chem. Soc. 1988, 110, 8164. Viehe, H. G.; Janousek, Z.; Merenyi, R.; Stella, L. Acc. Chem. Res. 1985, 18, 148. Penelle, J.; Padias, A. B.; Hall, H. K.; Tanaka, H. Adv. Polym. Sci. 1992, 102, 73.] 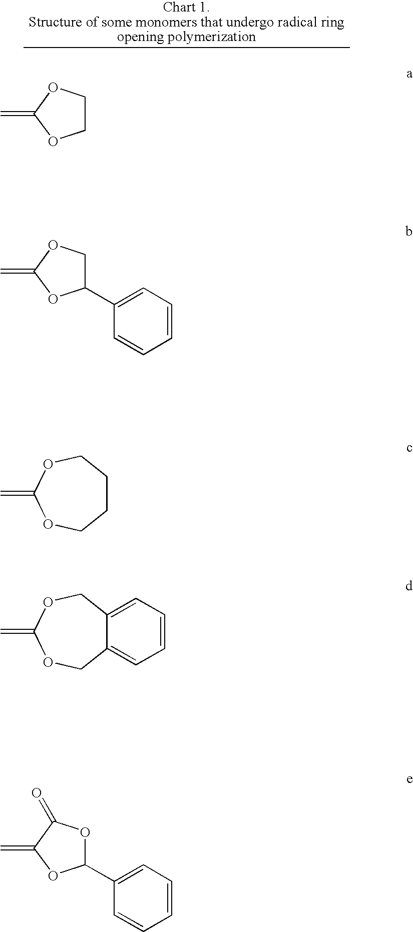
Such a monomer has previously been considered for radical ring-opening homo-polymerization forming a polymer with both attached cyclic ring and ring opened structures in the polymer backbone. (The extent of RROP was 50-80% depending on polymerization conditions). [Bailey, W. J.; Feng, P. Z. Polym. Prepr. (Am. Chem. Soc., Div. Polym. Chem.) 1987, 28(1), 154; Bailey, W. J.; Kuruganti, V. K. Polym. Mater. Sci. Eng. 1990, 62, 971; Feng, P. Chin. J. Polym. Sci. 1992, 10, 350.]

### BRIEF DESCRIPTION OF FIGURES

FIG. 1 is a graph of Iₙ[M]ₒ/M and conversion of monomer to polymer versus time in an ATRP of MPDO and MMA having an initial molar ratio of [MPDO]:[MMA] of approximately 1:10;

FIG. 2 is a graph of the relationship of Mn and Mw/Mn in the polymerization of FIG. 1;

FIG. 3 is a graph of the ¹H NMR Spectra of MPDO and poly(MPDO-stat-MMA) (CDCL₃, 300 MHz; *:solvent peak);

FIG. 4 is a graph of the GPC curves for the poly(MPDO-stat-MMA) polymer prepared by the ATRP for FIG. 1 indicating the decemization of the molecular weight by degradation by hydrolysis and photolysis;

FIG. 5 is a graph of conversion of each monomer versus time into the terpolymer in a batch polymerization;

FIG. 6 is a graph of the conversion of styrene and OMPD with time in an ATRP having an initial monomer ratio of [OMPD]: [styrene] approximately equal to 1:10;

FIG. 7 is a graph of the relationship of Mn and Mw/Mn in the polymerization of FIG. 6;

FIG. 8 is a graph of the GPC curves for the poly(OMPD-stat-styrene) copolymer produced in the polymerization of FIG. 6 and the polymers formed after hydrodegradation and photodegradation, hydrolysis or hydrodegradation of the copolymer with KOH (10 eq) resulted in a polymer with a Mn=1470 g/mol and a molecular weight distribution of approximately 2.27, photolytic degradation or photodegradation conducted with ultraviolet light for 2 hours resulted in degradation of the copolymer into polymers with an Mn=2040 and a molecular weight distribution of approximately 1.92;

FIG. 9 is a graph of the Iₙ[M]ₒ/M and conversion of monomer to polymer versus time in an polymerization of ethyl (1-ethoxy carbonyl)vinyl)phosphate;

FIG. 10 is a graph of reduction in molecular weight of pMMA-S—S-pMMA with Bu₃P for 1 hour at 50° C.; and

FIG. 11 is a graph of the GPC showing the molecular weight distribution of coupled thio terminated copolymers.

### SUMMARY OF THE INVENTION

Embodiments of the present invention are directed to a polymer, comprising a polymer backbone comprising one or more degradable units. The polymer may additionally comprise two or more polymer segments comprising radically (co)polymerizable vinyl monomer units. The degradable units may be independently selected from, but not limited to, at least one of hydrodegradable, photodegradable and biodegradable units between the polymer segments and dispersed along the polymer backbone. Further embodiments of a polymer comprising one or more degradable units may have a molecular weight distribution of less than 2.0. The degradable units may be derived from one or more monomers comprising a heterocyclic ring that is capable of undergoing radical ring opening polymerization, a coupling agent, or from a polymerization initiator, radically polymerizable monomers, as well as other reactive sources.

Embodiments of the degradable polymer of claim are capable of degrading by at least one of a hydrodegradation, photodegradation or biodegradation mechanisms to form at least one of telechelic oligomer and telechelic polymeric fragments of the polymer. The degradable polymer may be able to degrade into polymer fragments having a molecular weight distribution of less than 5, or in certain applications it may be preferable for embodiments of the polymer to be capable of forming polymer fragments having a molecular weight distribution of the polymer fragments less than 3.0 or even less than 2.5.

Embodiments of the present invention also include method of producing degradable polymers. One embodiment comprises copolymerizing heterocyclic monomers by radical ring opening polymerization and radically polymerizable monomers by a controlled polymerization process. Such an embodiment is capable of forming a polymer comprising a polymer backbone comprising the heterocyclic monomers and the radically polymerizable monomers. Further embodiments allow the heterocyclic monomer units are substantially randomly or statistically distributed along the backbone of the copolymer.

Further embodiments of the method of producing degradable polymers comprise coupling two or more polymers comprising a radically transferable atom or group with a linking compound comprising one or more degradable units selected from hydrodegradable, photodegradable, and biodegradable units. The linking compound may further comprise two or more radically polymerizable atoms or groups.

A further embodiment of the method of producing a degradable polymer comprises polymerizing radically polymerizable monomers with an initiator comprising a degradable unit selected from hydrodegradable, photodegradable, and biodegradable units and at least two radically transferable atoms or groups in an atom transfer radical polymerization process. The method may further comprise exposing the degradable polymer to a metal in metal in its zero oxidation state to form a polymer with degradable functionality dispersed along the chain.

The degradable unit is at least one group selected from ester, ether, ketone, amide, carbamate, acids, anhydride, sulfide, thio, and dithio groups, as well as other units that may be degraded by hydrolysis, photolysis, and/or biodegradation.

### DETAILED DESCRIPTION OF EMBODIMENTS OF THE INVENTION

Degradable Polymers and Polymeric Materials

Embodiments of the present invention include polymers and polymeric materials that undergo degradation by hydrolysis, photolysis or by biodegradation. The polymers and polymeric material may degrade into polymer fragments of lower molecular weight and in certain cases, forming telechelic polymer fragments. The degradation may occur in an external environment or within a living body. Embodiments of the polymer may comprise any monomer units that may be polymerized in a controlled polymerization process.

Exemplary degradable polymers include linear poly(meth)acrylates, polystyrenes and poly(meth)acrylamides containing degradable functionality in the polymer backbone. These exemplary degradable homo)polymers represent a small fraction of the degradable polymers that may be prepared by embodiments of the methods of the present invention and that are describe herein and that will become evident to one skilled in the art of copolymerization processes by an understanding the present invention. The degradable polymers may comprise any of radically (co)polymerizable monomers in any chain architecture, topology or functionality. As used herein, “degradable (homo)polymer” means a polymer comprising a concentration of one species of monomer unit of greater than 80% of the backbone monomer units and also comprises degradable functionality, or degradable units, dispersed along the polymer backbone. In embodiments of the degradable (homo)polymers, the degradable units are not concentrated in one segment, but dispersed along the polymer chain and hence the material behaves in a manner similar to the major component. However, the present invention includes polymers other than degradable (homo)polymers and degradable (co)polymers are often desired. Radically polymerizable monomers may provide a range of differing phylicities to the (co)polymeric materials prepared from them and the resulting polymer may range from water soluble copolymers to amphiphylic copolymers to zwiterionic copolymers or polymers comprising silicon based monomers or monomers comprising perfluro-substituents, a description of radically polymerizable monomers is included in the incorporated references. The degradable polymer backbones may be random or statistical polymers.

Embodiments of the polymers and polymeric materials of the present invention comprise degradable functional groups incorporated throughout the copolymer. Such a polymer or polymeric material is capable of degrading into polymer fragments having similar molecular weights, as measured by molecular weight distribution of the polymer fragments. The degradable units are distributed in the polymer or polymeric materials, such that the degradable polymer or polymeric material is capable of degrading into polymer fragments having a molecular weight distribution, or polydispersity index (“PDI”) less than 5, in some applications it may be preferable for embodiments of the present invention to degrade into polymer fragments having a molecular weight distribution less than 3.0 or less than 2.5, and these may be prepared.

Polymers prepared by other controlled polymerization processes including naturally occurring polymeric materials and copolymers, prepared by, for example, condensation polymerization processes contain terminal functional groups, comprising polymerizable functionality or polymerization groups or functional groups capable of being converted into a polymerizable functionality or initiating functionality may also be incorporated as macromonomers, macroinitiators or macro-AB* monomers in controlled radical polymerization processes for preparation of degradable polymers. An AB* monomer comprises both polymerizable and initiating functionality. In this way bio-compatabilizing segments comprising, for example, polyethylene oxide or polylactic acid, may be incorporated into degradable chains or degradable networks by reaction with radically copolymerizable monomers. Embodiments of the polymers and polymeric materials may also be prepared formed by application of the knowledge disclosed herein, wherein the polymers and polymeric materials comprise hybrid materials where the initiator for the CRP is first attached to an organic or an inorganic based backbone polymer, a particle or a surface.

An embodiment of a method of the present invention includes polymerizing ring opening polymerizable monomers with other radically polymerizable monomers to incorporate degradable functionality into the polymer or polymeric material. Any ring opening polymerizable monomer that results in incorporation of a degradable unit in the resulting polymer may be used. Ring opening polymerizable monomers that are capable of polymerizing to form, for example, an ester, ether, ketone, amide, carbamate, acids, anhydride, sulfide, thio, dithio or other degradable functionality that can undergo photo-, hydro- or biodegradation in the polymer backbone may be used. Examples of some ring opening polymerizable monomers having heterocyclic structures that are capable of forming a degradable unit in a polymer after undergoing ring opening polymerization include the monomers of Scheme 2, 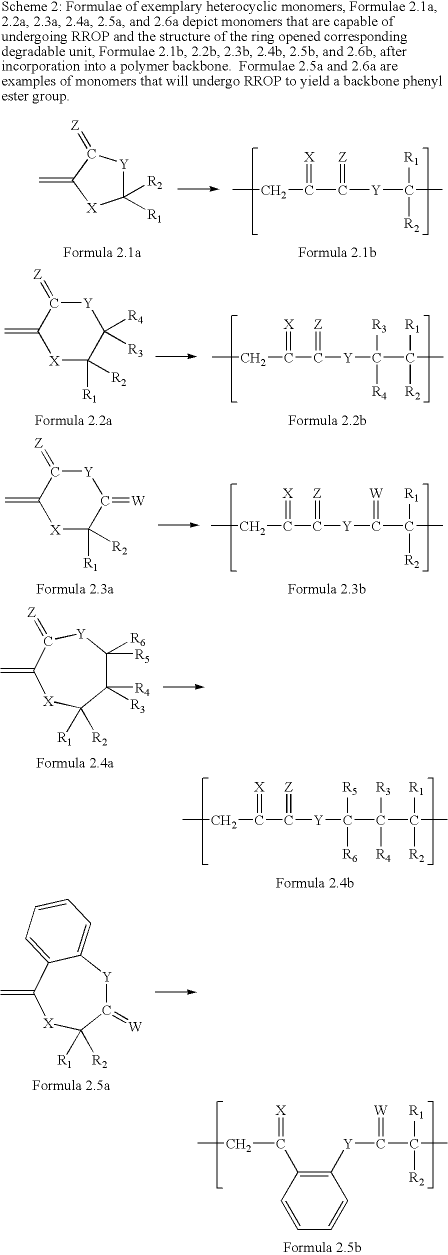 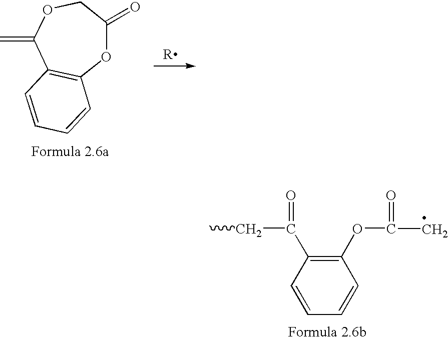
wherein W, X, Y and Z are independently selected from O, S, and N—R, where R is selected from the group H, alkyl, aryl, aralkyl, or cycloalkyl; and
R₁, R₂, R₃, R₄, R₅, and R₆ are independently selected from the group H, halogen, CN, CF₃, straight or branched alkyl of from 1 to 20 carbon atoms (preferably from 1 to 6 carbon atoms, more preferably from 1 to 4 carbon atoms), α,β-unsaturated straight or branched alkenyl or alkynyl of 2 to 10 carbon atoms (preferably from 2 to 6 carbon atoms, more preferably from 2 to 4 carbon atoms), α,β-unsaturated straight or branched alkenyl of 2 to 6 carbon atoms (preferably vinyl) which may be substituted with from 1 to (2n+1) halogen atoms where n is the number of carbon atoms of the alkyl group (e.g. CF₃), α,β-unsaturated straight or branched alkenyl or alkynyl of 2 to 10 carbon atoms (preferably from 2 to 6 carbon atoms, more preferably from 2 to 4 carbon atoms) which may be substituted with from 1 to (2n−1) halogen atoms (preferably chlorine) where n is the number of carbon atoms of the alkyl group (e.g. CH₂═CC1-), C₃-C₈ cycloalkyl which may be substituted with from 1 to (2n−1) halogen atoms (preferably chlorine) where n is the number of carbon atoms of the cycloalkyl group), C₃-C₈ cycloalkyl, heterocyclyl, C(═Y)R⁵, C(—Y)NR⁶R⁷, YC(═Y)R⁵, SOR⁵, SO₂R⁵, OSO₂R⁵, NR⁸SO₂R⁵, PR⁵₂, P(═Y)R⁵₂, YPR⁵₂, YP(═Y)R⁵₂, NR⁸₂ which may be quaternized with an additional R⁸ group, aryl and heterocyclyl; where Y may be NR⁸S or O (preferably O); R⁵ is alkyl of from 1 to 20 carbon atoms, alkoxy of from 1 to 20 carbon atoms, aryloxy or heterocyclyloxy, R⁶ and R⁷ are independently H or alkyl of from 1 to 20 carbon atoms, or R⁶ and R⁷ may be joined together to form an alkylene group of from 2 to 5 carbon atoms, thus forming a 3- to 6-membered ring, and R⁸ is H, straight or branched C₁-C₂₀ alkyl or aryl; and COOR⁹ (where R⁹ is H, an alkali metal, or a C₁-C₆ alkyl group); or
R₁ and R₃, or R₃ and R₄ may be joined to form a group of the formula (CH₂)ₙ, (which may be substituted with from 1 to 2n′ halogen atoms or C₁-C₄ alkyl groups) or C(═O)—Y—C(═O), where n′ is from 2 to 6 (preferably 3 or 4) and Y is as defined above.

Further, degradable unit may be formed during a chain extension reaction comprising one or more polymers and, optionally, added functional molecules that form the degradable group during a chain extension reaction or the degradable unit may be present in a radically copolymerizable monomer.

In the context of the present application, the term “alkynyl” refers to straight-chain or branched groups (except for C₁ and C₂ groups).

The term “alkenyl” as used herein refers to a branched or unbranched hydrocarbon group generally comprising 2 to 24 carbon atoms and containing at least one double bond, typically containing one to six double bonds, more typically one or two double bonds, e.g., ethenyl, n-propenyl, n-butenyl, octenyl, decenyl, and the like, as well as cycloalkenyl groups, such as cyclopentenyl, cyclohexenyl, and the like. The term “lower alkenyl” intends an alkenyl group of two to six carbon atoms, preferably two to four carbon atoms.

The term “alkylene” as used herein refers to a difunctional branched or unbranched saturated hydrocarbon group generally comprising 1 to 24 carbon atoms, such as methylene, ethylene, n-propylene, n-butylene, n-hexylene, decylene, tetradecylene, hexadecylene, and the like. The term “lower alkylene” refers to an alkylene group of one to six carbon atoms, preferably one to four carbon atoms.

The term “alkenylene” as used herein refers to a difunctional branched or unbranched hydrocarbon group generally comprising 2 to 24 carbon atoms and containing at least one double bond, such as ethenylene, n-propenylene, n-butenylene, n-hexenylene, and the like. The term “lower alkenylene” refers to an alkylene group of two to six carbon atoms, preferably two to four carbon atoms.

The term “alkoxy” as used herein refers to a substituent —O—R wherein R is alkyl as defined above. The term “lower alkoxy” refers to such a group wherein R is lower alkyl.

The term “halo” is used in its conventional sense to refer to a chloro, bromo, fluoro, or iodo substituent. In the compounds described and claimed herein, halo substituents are generally bromo, chloro or iodo, preferably bromo or chloro. The terms “haloalkyl,” “haloaryl” (or “halogenated alkyl” or “halogenated aryl”) refer to an alkyl or aryl group, respectively, in which at least one of the hydrogen atoms in the group has been replaced with a halogen atom.

The term “alkyl” as used herein refers to a branched or unbranched saturated hydrocarbon group generally comprising 1 to 24 carbon atoms, such as methyl, ethyl, n-propyl, isopropyl, n-butyl, isobutyl, t-butyl, octyl, decyl, tetradecyl, hexadecyl, eicosyl, tetracosyl, and the like, as well as cycloalkyl groups such as cyclopentyl, cyclohexyl, and the like. The term “lower alkyl” intends an alkyl group of one to six carbon atoms, preferably one to four carbon atoms.

The term “aryl” as used herein, and unless otherwise specified, refers to an aromatic moiety containing one to five aromatic rings. For aryl groups containing more than one aromatic ring, the rings may be fused or linked. Aryl groups are optionally substituted with one or more inert, nonhydrogen substituents per ring; suitable “inert, nonhydrogen” substituents include, for example, halo, haloalkyl (preferably halo-substituted lower alkyl), alkyl (preferably lower alkyl), alkenyl (preferably lower alkenyl), alkynyl (preferably lower alkynyl), alkoxy (preferably lower alkoxy), alkoxycarbonyl (preferably lower alkoxycarbonyl), carboxy, nitro, cyano and sulfonyl. Unless otherwise indicated, the term “aryl” is also intended to include heteroaromatic moieties, i.e., aromatic heterocycles. Generally the heteroatoms will be nitrogen, oxygen or sulfur. For example, aryl may refer to phenyl, naphthyl, phenanthryl, phenalenyl, anthracenyl, triphenylenyl, fluoranthenyl, pyrenyl, pentacenyl, chrysenyl, naphthacenyl, hexaphenyl, picenyl, and perylenyl (preferably, phenyl and naphthyl), in which each hydrogen atom may be replaced with alkyl of from 1 to 20 carbon atoms (preferably, from 1 to 6 carbon atoms and, more preferably, methyl), alkyl of from 1 to 20 carbon atoms (preferably, from 1 to 6 carbon atoms and, more preferably, methyl) in which each of the hydrogen atoms is independently replaced by a halide (preferably, a fluoride or a chloride), alkenyl of from 2 to 20 carbon atoms, alkynyl of from 1 to 20 carbon atoms, alkoxy of from 1 to 6 carbon atoms, alkylthio of from 1 to 6 carbon atoms, C₃-C₈ cycloalkyl, phenyl, halogen, NH₂, C₁-C₆-alkylamino, C₁-C₆-dialkylamino, and phenyl which may be substituted with from 1 to 5 halogen atoms and/or C₁-C₄ alkyl groups. Thus, phenyl may be substituted from 1 to 5 times and naphthyl may be substituted from 1 to 7 times (preferably, any aryl group, if substituted, is substituted from 1 to 3 times) with one of the above substituents. More preferably, “aryl” refers to phenyl, naphthyl, phenyl substituted from 1 to 5 times with fluorine or chlorine, and phenyl substituted from 1 to 3 times with a substituent selected from the group consisting of alkyl of from 1 to 6 carbon atoms, alkoxy of from 1 to 4 carbon atoms and phenyl.

This definition of “aryl” also applies similarly to the aryl groups in “aryloxy” and “aralkyl.” The term “inert” in reference to a substituent or compound means that the substituent or compound will not undergo modification either (1) in the presence of reagents that will likely contact the substituent or compound, or (2) under conditions that the substituent or compound will likely be subjected to (e.g., chemical processing carried out subsequent to attachment an “inert” moiety to a substrate surface).

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present, and, thus, the description includes structures wherein a non-hydrogen substituent is present and structures wherein a non-hydrogen substituent is not present.

The term “heterocyclic” refers to a five- to seven-membered monocyclic structure or to an eight- to eleven-membered bicyclic structure. The “heterocyclic” substituents herein may or may not be aromatic, i.e., they may be either heteroaryl or heterocycloalkyl. Each heterocycle consists of carbon atoms and from one to three, typically one or two, heteroatoms selected from the group consisting of nitrogen, oxygen and sulfur, typically nitrogen and/or oxygen. The term “nonheterocyclic” as used herein refers to a compound that is not heterocyclic as just defined. For example, “heterocyclyl” may refer to pyridyl, furyl, pyrrolyl, thienyl, imidazolyl, pyrazolyl, pyrazinyl, pyrimidinyl, pyridazinyl, pyranyl, indolyl, isoindolyl, indazolyl, benzofuryl, isobenzofuryl, benzothienyl, isobenzothienyl, chromenyl, xanthenyl, purinyl, pteridinyl, quinolyl, isoquinolyl, phthalazinyl, quinazolinyl, quinoxalinyl, naphthyridinyl, phenoxathinyl, carbazolyl, cinnolinyl, phenanthridinyl, acridinyl, 1,10-phenanthrolinyl, phenazinyl, phenoxazinyl, phenothiazinyl, dioxane, oxazolyl, thiazolyl, isoxazolyl, isothiazolyl, and hydrogenated forms thereof known to those in the art. Preferred heterocyclyl groups 2-vinyl oxazole, 5-vinyl oxazole, 2-vinyl thiazole, 5-vinyl thiazole, 2-vinyl imidazole, 5-vinyl imidazole, 3-vinyl pyrazole, 5-vinyl pyrazole, 3-vinyl pyridazine, 6-vinyl pyridazine, 3-vinyl isoxazole, 3-vinyl isothiazoles, 2-vinyl pyrimidine, 4-vinyl pyrimidine, 6-vinyl pyrimidine, and any vinyl pyrazine. The vinyl heterocycles mentioned above may bear one or more (preferably 1 or 2) C₁-C₆ alkyl or alkoxy groups, cyano groups, ester groups or halogen atoms, either on the vinyl group or the heterocyclyl group, but preferably on the heterocyclyl group. Further, those vinyl heterocycles which, when unsubstituted, contain an N—H group may be protected at that position with a conventional blocking or protecting group, such as a C₁-C₆ alkyl group, a tris-C₁-C₆ alkylsilyl group, an acyl group of the formula R¹⁰CO (where R¹⁰ is alkyl of from 1 to 20 carbon atoms, in which each of the hydrogen atoms may be independently replaced by halide, wherein the halide is preferably a fluoride or chloride, alkenyl of from 2 to 20 carbon atoms preferably vinyl), alkynyl of from 2 to 10 carbon atoms (preferably acetylenyl), phenyl which may be substituted with from 1 to 5 halogen atoms or alkyl groups of from 1 to 4 carbon atoms, or aralkyl (aryl-substituted alkyl, in which the aryl group is phenyl or substituted phenyl and the alkyl group is from 1 to 6 carbon atoms), etc. (This definition of “heterocyclyl” also applies to the heterocyclyl groups in “heterocyclyloxy” and “heterocyclic ring.”) The group selected for positions R₁ and R₂ and R₃ and R₄ affect the reactivity of the RROP radical at a copolymer chain end or the reactivity of the chain end for a chain extension reaction. The reactivity of the RROP radical may affect the rate of incorporation of the RROP monomer into the degradable polymer and changing the R₁ and R₂ and R₃ and R₄ group will change the regularity of the incorporation of the degradable unit along the polymer chain for a given comonomer.

The degradable polymers of the present invention may have a number average molecular weight of from 1,000 to 500,000 g/mol, preferably of from 2,000 to 250,000 g/mol, and more preferably of from 3,000 to 200,000 g/mol. When produced in bulk, the number average molecular weight may be up to 1,000,000 (with the same minimum weights as mentioned above). The number average molecular weight may be determined by size exclusion chromatography (SEC) or, when the initiator has a group which can be easily distinguished from the monomer(s) by NMR spectroscopy. Thus, the present invention also encompasses novel block, multi-block, star, gradient, random, graft, comb, hyperbranched and dendritic degradable copolymers, as well as degradable polymer networks and other degradable polymeric materials.

Methods for Preparing Degradable Polymers and Polymeric Materials

Embodiments of the present invention include methods of preparing polymers and polymeric materials that may undergo degradation by at least one of hydrolysis, photolysis, and/or biodegradation. An embodiment of the method includes copolymerizing at least two monomers by a controlled copolymerization process, wherein at least one of the comonomers comprises first functionality that is capable of incorporating a degradable functionality into the polymer by polymerization. Degradable functionality includes, but is not limited to, an ester, ether, ketone, amide, carbamate, acids, anhydride, sulfide, thio, dithio, or other degradable functionality that can undergo photo-, hydro- or bio-degradation. For example, ring opening polymerizable monomers, such as shown in Scheme 2, for example, are capable of incorporating degradable functionality into the polymer by (co)polymerization

A further embodiment includes polymerizing monomers with an initiator, wherein the initiator comprises a degradable functionality. In this embodiment, as well as others, the monomers may also include functionality that incorporates degradable functionality into the polymer during polymerization.

An embodiment of the method also includes polymerizing monomers in a chain extension polymerization to form degradable functionality. An another embodiment includes the use of a dual functional monomer comprising degradable functionality in a copolymerization or crosslinking reaction thereby forming a branched copolymer, star copolymer or network wherein the degradable functionality is incorporated at each linking unit.

Matching Reactivities and Adjusting Concentrations

One embodiment of the method of the present invention comprises selecting or preparing a monomer that forms a degradable unit in the polymer that has a similar reactivity to at least one other monomers in the polymerization medium. If the reactivity of the monomers is closely matched, the incorporation of the degradable unit may be more regularly incorporated into the degradable polymer. The rate of incorporation of the monomers would be related to the instantaneous concentration of monomers in the controlled polymerization medium, such an ATRP medium. An embodiment of selecting or preparing a monomer that forms a degradable unit comprises selecting a monomer that forms a degradable unit that has similar functional groups attached near the radical chain end formed during the controlled radical polymerization. During the polymerization, if the monomers are all incorporated at approximately the same rate, the instantaneous concentration of the monomers relative to each other will not change significantly and the monomers will be incorporated into the polymer backbone such that the molecular weight distribution of segments between the degradable functionality is less than 5.0, or more preferably less than 3.0, or even as low as less than 2.5. In certain embodiments comprising cyclic acrylates, for example, it may be preferred that that the substituents on the 2-position (R₁ and R₃) are selected to stabilize the propagating radical and also selected to provide a reactivity ratio close to that of one or more of the targeted comonomer(s).

One embodiment of matching the reactivity of the growing polymer chain ends formed by radical ring opening polymerization of the cyclic monomer and the radical formed from the a vinyl monomer, is further exemplified by the first of several approaches described herein to form a degradable polystyrene. This embodiment comprises copolymerizing styrene, or styrene based monomers, with a monomer capable of undergoing radical ring opening polymerization, such as, 2-oxo-3-methylene-5-phenyl-1,4-dioxane (OMPD). OMPD is a six membered ring shown as the formula 2.2a in Scheme 2 with X=O, Y=O, Z=O, R₁=phenyl, R₂=H, R₃=H, and R₄=H. Here the radical chain end of the ring opened cyclic monomer is similar to the radical chain end formed after addition of a styrene monomer unit to a growing radical. Since the structures of the compounds are similar, it would be expected that the reactivity ratio of these monomers would be close to one for the copolymerization of OMPD and vinyl aromatic monomers. The reactivity ratio of the primary monomer and the monomer capable of incorporating degradable functionality into the polymer may be between 0.25 and 4, preferably between 0.5 and 2 and even more preferably between 0.67 and 1.5, or even as close as 0.75 and 1.33, thereby providing copolymers with a random distribution of the degradable comonomer along the polymer backbone.

However, if the desired monomer combination does not have the desired reactivity ratio, such as 2-oxo-3-methylene-5-phenyl-1,4-dioxane with styrene, or is not easily available or another monomer is desired, and there are inherent differences in the reactivity ratio of the available cyclic monomer and the desired primary backbone comonomer, (i.e., the primary backbone comonomer that comprises greater than 50% of the desired backbone (co)monomer(s), or preferentially greater than 75% of the incorporated comonomers), a uniform distribution of the degradable functionality may still be attained by physical control over the copolymerization process. Control over the incorporation of the monomer capable of incorporating degradable functionality into the polymer backbone may be obtained by controlling the instantaneous concentration of the monomers, such as, but not limited to, by adding one or more monomers to a copolymerization process, or by reactive control, such as by a terpolymerization reaction. In either process, the comonomers may be added instantaneously or selectively in a continuous or discontinuous manner to control the instantaneous concentration of the monomers in the polymerization or reaction medium.

These three approaches are discussed below as means to attain the desired distribution of degradable functionality in a polymer backbone or polymer network but these approaches should not be taken as indicating a limit on the number of options available for controlled incorporation of a specific monomer into a growing polymer backbone. Other means will be apparent by considering, the kinetics of a specific copolymerization reaction, and the effect of some of the process options available, as described below. For instance, one embodiment that may used when the RROP comonomer is not incorporated into the desired polymer backbone in the desired distribution includes details of preparing of a degradable polymer by terpolymerization, such as of styrene, MMA and MPDO in a one step batch process. In this example, the rate of incorporation of MPDO into a (homo)polystyrene is dramatically increased by conducting a terpolymerization reaction through addition of MMA to the reaction. However as detailed below, even in such a terpolymerization system, if the final distribution of the degradable (co)monomer along the backbone of a material prepared in a single step batch process still requires fine tuning, one or more of the (co)monomers can be added periodically or continuously to the reaction, in order to adjust the instantaneous composition of all of the comonomers in the reaction medium, thereby controlling the rate of incorporation of the comonomers into the growing copolymer chain and therefore the distribution of the degradable functionality along the polymer backbone by considering both chemical and physical process parameters. Controlled addition of monomer(s) during a batch polymerization therefore can provide a material with the desired distribution of degradable functionality along the polymer backbone. These embodiments of the method of the present invention may be performed individually or in any combination to prepare degradable polymers.

Indeed, the sequence distribution of degradable monomer units, and, therefore, the degradable functionality, along a backbone can be controlled, even if the reactivity ratios of the comonomers are not favorable. An embodiment of the method of the present invention includes periodically or continuously adding one or more of the comonomers to the reaction or polymerization medium. One monomer could be added periodically and another continuously or in any combination to adjust composition to account for reactivity ratio's and obtain the desired distribution of degradable functionality along the polymer backbone. This procedure of sequential or periodic addition of one or more reactive comonomers can lead to the formation of a periodic copolymer, or to formation of a segmented tapered block copolymer, where the active monomer(s) are distributed along the polymer backbone linking blocks that do not contain degradable functionality.

5-methylene-2-phenyl-1,3-dioxan-4-one (MPDO; Chart 1. structure “e”) may be a highly reactive monomer in a copolymerization reaction due to the presence of a radical stabilizing α-ester group. A copolymer formed by radical ring-opening polymerization of MPDO with a fully ring-opened structure with α-keto ester groups in the backbone providing potential sites for both biodegradability (the —C═O—O bond) and photo-degradability (the C═O—C═O bond). No copolymerization studies have been reported for MPDO, but we envisioned, and herein demonstrate, that the high reactivity of MPDO may enhance the probability for its incorporation into the backbone in controlled copolymerization reactions with styrene(s), (meth)acrylate(s), (meth)acrylamide(s), and other radically (co)polymerizable monomers and macromonomers, or with complexed olefinic monomers that can undergo radical copolymerization. The resulting copolymers with dispersed in-chain α-keto ester groups should preserve the capability for both biodegradability and photo-degradability. This process would allow copolymers based on vinyl monomers to be designed to easily (slowly and predictably) degrade to telechelic oligo/polymer fragments, particularly functional polymeric fragments with a relatively narrow MWD, i.e., polymer fragments with a PDI less than 10, preferably less than 5.0, and most preferably less than 3.0, and optimally less than 2.5 and close to 2.0. In certain biological applications, such a narrow MWD may be desirable since the polymer fragments should have a similar molecular weight in order to be processed in a similar manner by the body. This ability to control the degradation process, the rate and degree of degradation, the composition, and the molecular weight of the polymer fragments, should allow such materials to find application in high value applications, such as drug delivery systems and tissue engineering, for example, in addition to disposable or recyclable systems, such as foams, films, including agricultural films, and other solid articles. In a CRP, it is possible to incorporate additional functionality for attachment of drugs by selection of a functional comonomer bearing the appropriate attachment group.

In addition to selection of comonomers when targeting biocompatible polymers in addition to biodegradable polymers we note, from earlier cited references that while monomers such as MPDO can undergo copolymerization by a ring opening process they can also undergo copolymerization by direct incorporation of the heterocyclic monomer into the polymer backbone. The later direct incorporation process also provides useful materials that can lead to biocompatible copolymers. The amount of monomer incorporated by RROP is increased by running the copolymerization under more dilute conditions.

We are not limited to monocyclic heterocyclic RROP monomers since bicyclic materials can also undergo RROP as exemplified by RROP of 8-methylene-1,4-dioxaspiro-[4.5]deca-6,9-diene. [Scheme 19 in a review article by Sanda, F.; Endo, T. Journal of Polymer Science, Part A: Polymer Chemistry 2000, 39, 265-276.] Addition of a donor substituent in the 3-position forming 8-methylene-1,4-dioxaspiro-3-keto-[4.5]deca-6,9-diene, would introduce an active α-keto ester group into the polymer backbone.

We are not limited to copolymers with dispersed in-chain α-keto ester groups since other heterocyclic molecules can undergo radical ring opening polymerization and can be employed for the preparation of (co)polymers. Indeed any cyclic, bicyclic, or polycyclic unsaturated molecule that can undergo radical ring opening polymerization that comprise two or more heteroatoms directly or indirectly linked to each other are preferred. The heteroatoms can be the same or different heteroatoms as long as the functionality resulting from radical ring opening polymerization provides degradability to the resulting copolymer. Some of the structures for heterocyclic monomers that can undergo RROP and the structure of the ring opened monomer unit after incorporation into a (co)polymer backbone are shown in Scheme 2. These molecules, and other captodative molecules, can be used to incorporate functionality that can be employed to integrate bio-compatible or bio-active functionality into the polymer. Such polymers can additionally comprise both biodegradability and photo-degradability thereby tailoring the material for functional applications and environmentally targeted degradation.

An embodiment of the method of the present invention is exemplified by formation of a degradable polystyrene by copolymerizing styrene and MPDO. The embodiment comprises intermittently adding a highly reactive monomer capable of incorporating a degradable unit into the polymer backbone to an active controlled polymerization process, such as, for example, an ATRP, NMP, or a RAFT process. Preferably, the monomer capable of incorporating a degradable unit into the backbone may be 10 times more reactive or, more preferably, 50 times more reactive or even 100 times. Due to the relative reactivity ratio of MPDO and styrene, the RROP comonomer, MPDO, would be preferentially incorporated into the copolymer backbone after its addition. After the MPDO in the polymerization media is depleted, homopolymerization of a polystyrene segment would occur resulting in a block copolymer. In order to prepare a copolymer with distributed degradable functionality, the more reactive comonomer, MPDO, may be added continuously or periodically to the polymerization reaction to provide a degradable copolymer wherein the degradable functionality is incorporated periodically along the copolymer backbone. A degradable polystyrene was successfully prepared by multiple additions of MPDO to an active polystyrene polymerization resulting in regular distribution of degradable functionality along the backbone of the final polymer. Through this embodiment of the present invention, a degradable polystyrene may be formed that is capable of degrading into polymer fragments with a molecular weight distribution of less than 5, or with changes in the addition method less than 3.0 or less than 2.5.

By selecting conditions that provide the desired instantaneous ratio of (co)monomers throughout a controlled polymerization process one can thereby pre-select the molecular weight of the oligo/polymer fragments after degradation. This can be accomplished for copolymers incorporating any vinyl based monomer, including vinyl terminated macromonomers prepared by non-radical polymerization processes.

The oligomer and polymer fragments formed after degradation may also have industrial utility. An embodiment of the present invention includes preparing a degradable polymer, exposing the degradable polymer to conditions capable of degrading the polymer, and recycling the fragments to for a new polymer or in a separate process. The terminal functionality of the oligomer and polymer fragments may be predetermined by selection of the first RROP comonomer, and the conditions of degradation. The polymer will degrade at the degradable functionality and the resultant groups will be attached to the terminal end of the oligomer and polymer fragments. The resulting telechelic fragments may be recycled in coupling or chain extension reactions or find use as building blocks in condensation polymerizations, such as formation of polyurethanes, polyesters, and polyamides.

This embodiment of the method of the present invention is first exemplified herein by the preparation of both a degradable poly((M)MA) and degradable poly(styrene(s)) using several different process embodiments. The degradable copolymers are prepared with varying levels of functionality dispersed along the copolymer backbone thereby teaching how to prepare compositionally homogeneous polymers that can be selectively degraded to oligo/polymer fragments of any pre-selectable, or targeted molecular weight and terminal functionality. While MMA and styrene are initially used herein as radically (co)polymerizable monomers to exemplify the incorporation of a degradable functionality, or degradable copolymer segments, into a polymer backbone, other functional monomers, i.e., monomers bearing reactive functionality such as amines, alcohols or acids or derivatives thereof, which have been polymerized directly, or in a protected form, by CRP techniques can also be used to form (homo)polymers, (co)polymers, block copolymers, graft copolymers, branch copolymers, star copolymers, or polymer networks, thereby providing a functional polymer comprising additional functionality that can undergo hydro- photo- or bio-degradability.

This embodiment also find utility for polymers comprising monomers other than MMA and styrene and for the polymers that may be used for biodegradation where one wishes to pre-select the molecular weight and composition of the degraded molecular fragments so that they can be selectively adsorbed or expelled from the body. For instance, polymer segments wherein the final average molecular weight of the degraded fragments is less than 30,000, preferentially less than 15,000 and indeed can be targeted to be significantly lower if desired.

Degradable copolymers prepared by a controlled polymerization processes to produce block copolymers, segments in graft copolymers or even segments in polymer networks, wherein one or more of the blocks, grafts, or segments may include degradable functionality and others may not. Embodiments of such polymers include block copolymers that include segments or blocks capable to act as carriers for drugs or materials for incorporation into tissue engineering and biodegradable blocks or segments. Such functional biologically active segments may be incorporated in graft copolymer segments. Embodiments of the graft copolymers may be prepared by any grafting process, such as, but not limited to, grafting to, grafting through or grafting from processes. A “grafting through” process has been described for incorporation of polylactic acid macromonomers into a CRP in co-assigned U.S. application Ser. No. 10/034,908, which is hereby incorporated by reference, and exemplifies how bio-compatible and bio-inert materials can be incorporated into block, gradient and gradient block graft polymers. Indeed we further teach herein the (co)polymerization of captodative monomers comprising functionality that can form attached acid functionality that can be used in bio-mineralization processes or can be used to incorporate or bind other functional molecules to the degradable matrix using known chemistry.

As taught in referenced applications and papers there are several approaches to prepare graft copolymers and a variation of the “grafting to” process is incorporation of functionality into the polymer backbone that can interact with bio-active materials directly thereby incorporating them into the material that can additionally comprise degradability either in the backbone or in the link.

The preparation of a degradable bio-compatible material using a monomer known to be polymerizable by CRP processes can be exemplified by the preparation of 2-hydroxyethyl methacrylate (HEMA) with a comonomer that can undergo radical ring opening polymerization (RROP) providing a backbone polymer with an ester, ether, ketone, amide, carbamate, sulfide, thio or other degradable functionality that can undergo photo-, hydro- or bio-degradation.

Further embodiments include random copolymers of dimethyl acrylamide, including preparation of degradable copolymers of N-(2-hydroxypropyl) methacrylamide. Copolymers of dimethyl (meth)acrylamide(s) can be prepared by direct copolymerization of dimethyl acrylamide or a protected derivative, such as oxysuccinimide methacrylate; indeed poly(N-hydroxysuccinimide methacrylate) is a possible precursor of both poly(methacrylamides) and PMMA. Controlled (co)polymerization, indeed controlled stero(co)polymerization, of these monomers has been described in co-assigned applications and preparation of copolymers comprising such segments can be formed by copolymerization or chain extension reactions of telefunctional copolymers as discussed herein.

Poly-N-(2-hydroxypropyl)meth acrylamides (HOPMAA) have been shown to be materials that can be used for drug delivery. [Sakuma, S.; Lu, Z.-R.; Pecharova, B.; Kopeckova, P.; Kopecek, J. Journal of Bioactive and Compatible Polymers 2002, 17,305-319.] The addition of controlled bio-degradability to such materials will allow drug delivery composite materials to be implanted or inserted into a body and as, or after, the drug is released at the desired rate the carrier can then degrade, or be degraded, to absorbable and/or exudeable products. The degradation could be designed to occur via hydrolysis, by enzymatic action, by (co)injectable materials, by materials present in the body or could be stimulated by light.

Embodiments also include controlled copolymerization from polyethylene oxide (PEO) macroinitiators and use of PEO-MMA and PEO-MA macromonomers for the preparation of vinyl based copolymers. These block, graft, multi-graft or network structures may now also be prepared with additional degradable functionality in the backbone or throughout the macromolecule or network. PEO based copolymers are bio-compatible materials and can be used as linear polymers in a similar way to HOPMAA copolymers or they can be crosslinked to form hydrophilic gels with degradable crosslinks and optionally degradable backbones and are discussed herein as further examples of exemplary bio-compatible materials that can now additionally comprise additional degradability. The degradable unit can also have biofunctionality. This embodiment is exemplified by preparation of copolymers comprising a dithio-linking group that is selectively degraded in a reducing environment. Cancer cells provide such an environment and these copolymers would be selectively adsorbed at the site that leads to their degradation thereby providing a means to selectively deliver agents to the cancerous cells.

Degradation of the degradable units may be induced by photolysis, by hydrolysis or other conditions at the target environment. Hydrolysis can be conducted in neutral, acidic or basic media. The activation of the degradable functionality can be selected to optimally occur in the final environment envisioned for the material or by external stimulation of the degradable link at the desired time. The ease of degradability, for example, can be controlled by compositional selection of the heteroatoms W, X, Y or Z, and the arrangement of the X or Y and C=W or C=Z groups of in the monomers of Scheme 2, in the first heterocyclic RROP monomer, initiator, linear comonomer or formed during construction of the linking group and is exemplified by identification and incorporation of RROP monomers that provide a more hydrolytically reactive phenylester group in the backbone and by incorporation of an even more reactive anhydride group into the backbone.

As mentioned above, photo-degradability can be incorporated into the backbone of any vinyl-based copolymer segment and this can be used to incorporate photo-sensitive degradable materials into the preparation of electronic materials. The polymers can be spun onto a substrate then selectively degraded by exposure to light providing low molecular weight fragments that can be washed from the surface leaving behind the desired pattern of higher molecular weight insulating polymer. Radically copolymerizable monomers are presently not considered to be the most appropriate building blocks for materials targeted at electronic applications but the first polymer does not have to comprise only vinyl-based monomers but can comprise the degradable vinyl-based copolymers as segment(s) linking a step growth polymer of any desired composition. (U.S. Pat. No. 5,945,491 exemplifies use of a polysulfone as a macroinitiator for ATRP but a similar approach can be used to incorporate polyimide, polyarylester or polysiloxane segments into a block copolymer additionally comprising radically (co)polymerizable monomers.)

Indeed this approach can be used to reduce the environmental impact of processes currently employed in the manufacture of electronic materials. The second radically copolymerizable monomers can be selected to be hydrophilic monomer units and the degradable precursor molecule selected to be quickly incorporated into the radically polymerized copolymer thereby providing a water dispersible system that can undergo phase separation on a surface followed by cleavage of the degradable group providing a water soluble fraction and a water insoluble fraction comprising the desired engineering resin.

Further since the degraded fragments may be telechelic materials they may be incorporated into further chain extension reactions. Indeed the controlled copolymerization of monomers providing degradable functionality to the first copolymer is a route to preparation of telechelic oligo/polymers with desired terminal functionality including hydroxyl, carboxylic acid, amino and thio functionality, and derivatives thereof.

As a result of the extensive experience of the inventors with ATRP, ATRP has been used as the controlled radical polymerization process system as a model for all controlled radical polymerization processes. The procedures described below can be easily converted to a stable free radical mediated polymerization (SFRP) or nitroxide mediated polymerization (NMP) without any change in the structure of the comonomer that undergoes ring opening polymerization. However, in the case of RAFT copolymerization of RROP monomers comprising different heteroatom(s) may be preferred. The monomers first used to exemplify this concept in ATRP comprise oxygen as the hetero-atom in the unsaturated heterocyclic monomers that undergo RROP, however one or more of the oxygen atoms can be other hetero-atoms, such as sulfur, nitrogen, phosphorous, or boron.

Sulfur containing heterocyclics have been shown to undergo radical ring opening polymerization, Scheme 3, and the preparation and use of monomers additionally incorporating degradable functionality, as taught herein, could be employed in RAFT copolymerizations. Examples of initiators with degradable dithio links will be provided along with examples of a telechelic copolymer comprising thio functionality that can be coupled to form a degradable dithio function in the resulting chain.

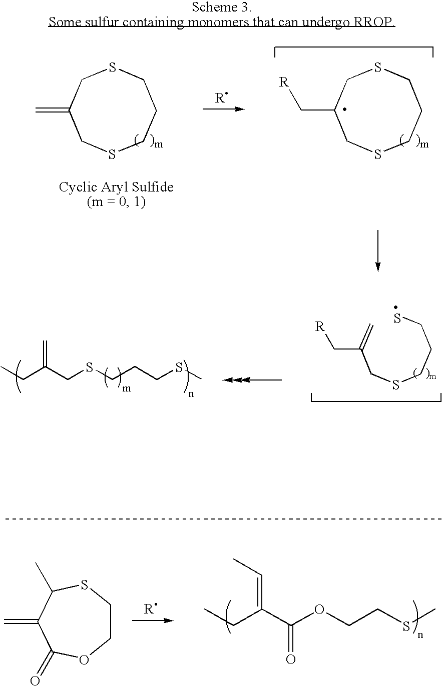

The ease of degradability can be enhanced by incorporation of additional stabilizing functionality at the sites adjacent to the atoms that will be cleaved by hydrolysis or photolysis. (Note that the structures on the heterocyclic monomers shown in Scheme 3 are different than those shown in scheme 2 indicating that the range of suitable heterocyclic monomers that can undergo RROP are not limited to those indicated herein as exemplary RROP monomers.)

It has been considered that captodative-substituted vinylidene monomers represent poor candidates for radical polymerization because of the enhanced stabilization of the propagating radical by electron withdrawing (capto) and donating (dative) substituents on the same radical center. However, with the success of the radical ring opening (co)polymerization of the captodative monomers detailed above, and below in the examples section, and the report that some captodative monomers have been polymerized to high molecular weight; two captodative monomers, methyl α-trimethylsiloxyacrylate and dimethyl (1-ethoxycarbonyl)vinyl phosphate, were prepared to examine their (co)polymerization behavior by CRP. It was expected that the resulting (co)polymers would be useful materials because of the inherent functionality in the monomer and because the first incorporated functionality can additionally expand the utility of resulting (co)polymers because they can be converted to hydroxyl functionality after hydrolysis. [(a) Colvin, E. W. Silicon in Organic Chemistry 2nd Ed., Krieger, Malabar (1985). (b) In the case of dimethyl (1-ethoxycarbonyl)vinyl phosphate, the phosphate group is selectively hydrolyzed to produce phosphoric acid with two —OH groups; Stubbe, J. A.; Kenyon, G. L. Biochemistry 1972, 11, 338.] Indeed the copolymerization of captodative monomers that comprise such useful functionality, that can additionally be used to incorporate bio-active materials, can provide materials that can be dispersed better in the living system due to the incorporated charges. Further, the addition of acid functionality, such as acrylic acid, SO₃ or phosphates to a material comprising inorganic salts will assist controlling the setting time and final structure of the composite; examples of utility range from dental composites to concrete. With the ability to polymerize these monomers by a controlled radical polymerization process they can be incorporated into materials with any intra-molecular topology, including block copolymers, and be copolymerized with a full range of comonomers providing solubility in selected solvents, including water and other biocompatible media. The water soluble monomers can include water soluble radically polymerizable monomers, such as hydroxyethyl methacrylate (HEMA) or water soluble macromonomers, such as PEO-MA or PLA-MMA.

The final degradable polymer can also be prepared by coupling telechelic oligo/polymer fragments by procedures described for small molecules in the literature and in the cited prior art. A prepolymer prepared by a living/controlled polymerization process from a difunctional initiator additionally comprising a degradable functionality contains that degradable functionality within the polymer chain. When such a polymer is chain extended to higher molecular weight by various coupling procedures or condensation polymerization techniques the final polymer contains dispersed degradable functionality along the polymer chain. Degradation of the polymer at these first initiator residue degradable groups will form polymer fragments of the same molecular weight as the first copolymer. The first difunctional initiator additionally comprising a degradable functionality can be a small molecule, herein exemplified by Br—C(CH₃)₂—CO—O—CH₂—CH₂—O—CO—C(CH₃)₂—Br made from ethylene glycol, or can comprise a degradable polymer segment, herein exemplified by a structurally similar macroinitiator, Br—C(CH₃)₂—CO—O—(CH₂—CH₂—O—)ₙCO—C(CH₃)₂—Br. The example of ethylene oxide or polyethylene oxide is not limiting in any manner since the incorporated degradable units can comprise any of the functionalities described above in the discussion of RROP monomers but can further include other synthetic or naturally produced biodegradable polymer fragments. This would include degradable polymers, such as polylactic acid or copolymers with degradable linking units based on acids, esters, amides, dithio groups or others listed above as suitable degradable links in a ring opened RROP monomer.

The approaches discussed will prepare essentially linear copolymers however copolymerization of a vinyl based monomer with an AB* monomer comprising a vinyl polymerizable group, an initiating moiety and between these two functional groups a third function, a degradable group, will introduce degradable functionality into a branched copolymer. Two simple examples would be chlorovinylacetate, CH₂═CH—CO—O—CH₂—Cl, or CH₂═CR—CO—O—CH₂—CH₂—O—CO—C(CH₃)₂—Br, where R═H, CH₃, or other substituents. AB* monomer with higher molecular weight degradable segments would be preferred when faster degradation is desired since the environment around the degradable unit is somewhat constrained. These lower molecular weight. AB* monomers are therefore used solely as examples since by employing the strategy employed in its synthesis a vast range of AB* monomers and macromonomers can be constructed. All three components can be selected for optimal performance in the synthesis and ultimate application. E.g. The exemplary AB* monomer is formed by reaction of a 2-hydroxyethyl(meth)acrylate (which can be considered a combination of the polymerizable unit (an acrylate) with the degradable unit (ethylene glycol)) with bromoisobutyrate (the initiating unit). The AB* monomer could however be a macromonomer comprising degradable functionality as discussed above.

If a network is targeted then a divinyl-monomer could be employed, non-limiting examples again based on the simple example of a core ethylene glycol or dicarboxyethane as degradable unit a structure would provide linking monomers, such as CH₂═CR—CO—O—CH₂—CH₂—O—CO—CR═CH₂; or CH₂═CR—O—CO—CH₂—CH₂—CO—O—CR═CH₂. However macro-degradable units could be employed.

All these approaches to degradable polymers that can undergo photo-, hydro-, and biodegradability to polymer fragments of predictable size will be exemplified below but the limited number of examples should not be considered as limiting the number of different routes available to attain these desirable structures, nor the compositions of the attainable polymers additionally comprising degradable functionality.

Often polymers with functional end groups, such as silyl, carboxy, amino, thio, or hydroxyl-end groups are desired for chain extension reactions. Described herein is an exemplary process to prepare dihydroxy polymers based on (meth)acrylate comonomers. This process is based on a coupling process where the radically transferable atom(s) are removed from the active chain end under conditions that favor coupling of radicals. This reaction is specifically described using a polyacrylate only to exemplify this procedure since polymers with differing end groups and differing backbone composition, as described in referenced applications, can be employed to prepare telechelic polymers with desired backbone compositions in addition to homo-telechelic functionality.

Further, to demonstrate incorporation of additional functionality into the linking groups of a coupling reaction the first telechelic polymers will be used in the synthesis of polyester-polyMA sequential block copolymers that can provide degradability through the presence of the ester groups and the composition of the linking molecule.

Direct radical based coupling of (meth)acrylates is not as efficient as styrene based coupling reactions since acrylates is more prone to undergo radical-radical disproportionation. This can be overcome by the addition of styrene as a capping/coupling agent. The amount of styrene can be as low as 0.5 mole and efficient coupling still occur. This procedure is exemplified by the addition of 1 or 2 units of styrene to an acrylate (co)polymerization before coupling and via adding 1 or 2 units of MA, then 1 or 2 units of styrene before coupling an oligo/poly(methacrylate).

Further, the preparation of homo-telechelic (meth)acrylates can be exemplified by the preparing a dihydroxy-MMA and used in coupling or chain extension reactions. It was shown that chains of varying length could be produced. Long chains may be synthesized, very short chains, however, allow the OH functionality to be seen by ¹H NMR and 2D Chromatography.

Another embodiment of the present invention comprises polymerizing from an initiator comprising degradable functionality, such as, a difunctional Br initiator (Br—C(CH₃)₂—CO—O—CH₂—CH₂—O—CO—C(CH₃)₂—Br), initiator. Such an initiator may be made from ethylene glycol, which may be used to introduce cleavable ester linkages into polystyrene. Embodiments of the polymers have short polystyrene units (MW<2000) that may be separated by the biodegradable ester linkage. A similar degradable link can be introduced by the preparation of a dihydroxy(polystyrene), (Mₙ of HO—PST-OH=3100) followed by reaction with adipic acid. If a longer degradable linking group was desired then a naturally degradable polymer further comprising selected tele-functionality such as dicarboxy-poly(lactic acid) could be employed.

Another embodiment comprises preparing a first copolymer comprising carboxylic acid groups and then chain extending the coupled telechelic diacid copolymers by reaction with a degradable polydiol such as PEO.

The coupling reaction described above for the preparation of homo-telechelic polymer fragments can also be employed as the chain extension reaction. Incorporated references describe this reaction as atom transfer radical coupling, (ATRC) wherein a copolymer prepared by ATRP reaction is exposed to an excess of a metal in the zero oxidation state. Examples with copper and iron, generating macroradicals in situ by an atom transfer process. However, in contrast to ATRP, the concentration of radicals is not require to be moderated to control polymerization, but rather to allow coupling. Coupling reactions may be performed on both mono and dibrominated polystyrene or styrene capped (meth)acrylates using efficient nanosize Cu⁰. The ATRC reaction was influenced by the nature of ligand, as well as the amounts of ligand and zerovalent metal used in the process. Good coupling efficiencies were obtained when PMDETA and dNbpy were used as ligands, for ATRC of both mono and dibrominated PSt. When mixtures of mono and dibrominated PSt were employed in coupling reactions, the molecular weights of the resulting polymers were influenced by the ratio between the mono- and di-bromine terminated polymers. This is the result of the number of successive couplings of the dibrominated polymer being limited by the presence of monobrominated chains. In this manner the final molecular weight of the coupled copolymer can be controlled. Coupling can also be induced by other transition metals such as iron zero, which could be considered a more environmentally benign transition metal. A monomer based atom transfer radical coupling agent, described in U.S. patent application Ser. Nos. 09/534,827 or 10/788,995, can also be employed in a catalytic coupling process.

An exemplary approach to the embodiment for incorporation of degradable functionality into radically copolymerizable copolymers involves the preparing an initiator for an ATRP that additionally comprises a non-radically transferable functional group. 2,2-Dimethyl-3-hydroxypropyl α-bromoisobutyrate was synthesized using a procedure previously reported by Newman [Newman, M. S.; Kilbourn, E. J. Org. Chem. 1970, 35, 3186-3188] and was used to prepare a mono-hydroxy-functionalized PMA. (In the examples detailed below NPbiB stands for this neopentyloxy bromoisobutyrate initiator). The first prepared hetero-telechelic polymethyl acrylate, with a hydroxy-functionality remaining attached to the initiator residue and a bromo-functionality at the active growing chain end, was formed by conducting an ATRP of methyl acrylate with this initiator. This polymer was prepared and subjected to a series of coupling reactions in the presence of transition metal complexes comprising different ligands, differing reducing agents and differing concentrations of styrene as a coupling aid. Successful coupling reactions were demonstrated and it was determined that 100% efficient coupling of active (meth)acrylate copolymers occurred in the presence of as little as 0.5 mole of added styrene.

We demonstrate herein that when coupling is applied to polymers with one radically transferable atom or group homo-telechelic polymers are prepared.

Further when coupling is applied to polymers with two radically transferable atoms or groups a chain extension can occur.

Further, when selected functionality is first incorporated into the initiator molecule, or coupling molecule, this functionality can be incorporated and distributed along the backbone. When this selected functionality is selected to comprise a degradable functional group then a degradable copolymer can be formed. The degradable functionality can comprise photo-, hydro-, or bio-degradable functionality or mixtures thereof.

Further, when coupling is applied to a mixture of polymers with one radically transferable atom and polymers with two radically transferable atoms this can lead to polymers with controlled or targeted molecular weight distribution and controlled distributed degradable functionality. Polymers comprising degradable functionality can, therefore, also be prepared by the presently discussed coupling processes and through use of homotelechelic copolymers in known polycondensation chemistry.

It is now possible to attach an ATRP initiating functionality to a degradable functionality prior to conducting an ATRP. Further degradable functionality that can optionally be incorporated during chain extension reactions can comprise the same functionality present in the functional initiator or a differing degradable functionality can be incorporated into the polymer backbone through utilization of a functional co-coupling agent. Incorporation of degradable functionality through use of a functional initiator and a functional co-coupling agent will be described. It is, therefore, possible to use such a process to form a copolymer with two different functional links or segments dispersed along the copolymer backbone that would degrade by two different mechanisms thereby increasing the likelihood of degradation.

Use of an initiator that contains additional functionality that would be photo- or biodegradable, as described above, would after the ATRP (co)polymerization have two terminal halo-groups and a degradable functionality within the chain. This polymer could be chain extended by a further ATRC reaction in the presence of iron zero. This would form a high molecular weight polymer with degradable functionality dispersed along the chain. When fragmented the molecular weight of the polymer fragments may be the same as the first polymer.

In a second embodiment to the preparation of degradable polymers prepared by coupling reactions, comprised adding a second difunctional ATRP initiator molecule with a different degradable functionality could be added to first polymer prepared by ATRP and adding iron zero. The resulting ATRC chain extension would form a high molecular weight copolymer with two different degradable functional groups evenly spaced along the chain. The degradable functional groups could promote degradation by the same mechanism or differing mechanisms. If the degradation occurs solely by either mechanism this would lead to a fragmented copolymer with the same MW as the first polymer. Fragmentation by both mechanisms would lead to a polymer with half the MW of the first polymer. Note, however, that there could be some small molecule to small molecule coupling prior to incorporation of the chain extended copolymer and this could reduce the level of control over the ultimate molecular weight of the polymer but result in an increase in its overall degradability due to the presence of adjacent degradable units.

In the following series of examples, a first telechelic polyacrylate is prepared and a small amount of styrene (0.5-2 mole) is added to the end of the acrylate polymerization using a functional initiator and the first formed polymer is coupled to form a difunctional homo-telechelic polymer with narrow molecular weight distribution.

When a difunctional initiator is used in first (meth)acrylate ATRP and then the resulting difunctional macromolecule is coupled, a much higher molecular weight polymer is prepared.

When the initiator for the first ATRP reaction comprises additional degradable functionality the final poly(meth)acrylate polymer comprises the functionality distributed along the polymer backbone.

When the homo-telechelic polymer is used in a chain extension reaction functional linking groups are incorporated into the copolymer.

When a functional initiator and a functional coupling agent are employed differing functionality can be incorporated into the polymer backbone.

When the amount of coupling aid is less than the optimum for a “clean” coupling reaction, i.e., less than 1 mole or even less than 0.5 mole, then some termination through disproportionation can occur and the formed functional macromonomer can be incorporated into the final coupled polymer as a graft segment.

The disclosed process can form functional copolymers wherein all radically transferable atoms or groups have been removed.
X—R-D-R′—X Formula 3

Further when the added coupling agent additionally comprises a degradable functionality then additional degradable functionality can be incorporated into the final polymer. The added coupling agent can also comprise a molecule with two radically transferable atoms or groups and the resulting copolymer will comprise a statistical coupling of the first polymer and the added second polymer.

When the coupling molecule further comprises an inline third functionality this additional functionality is incorporated and distributed along the formed copolymer backbone. Such an initiator or coupling agent can comprise molecules of the Formula 3 wherein X can be a radically transferable atom or group or an unsaturated alkene as described above, R is an inert linking group and D is an inline functional group capable of undergoing degradation by photo-, hydro-, or bio-degradation reaction under conditions normally encountered in the environment or in a living body.

A further route to chain extended polymers comprising distributed functionality can comprise addition of a telechelic polymer, such as that formed by coupling of a polymer formed by conducting an ATRP using a mono-functional initiator further comprising a functional group and coupling the formed polymer to produce a homo-telechelic polymer suitable for use as a macromonomer in a condensation type copolymerization wherein the second formed polymer comprises linking groups that are photo-, hydro-, or bio-degradable. This is exemplified by the formation of polystyrene with distributed ester functionality by reaction of an α,ω-dihydroxypolystyrene with a diacid.

The same functional groups discussed above as being suitable as macro-initiators for an ATRC reaction can also be incorporated as the functional degradable group into an AB* monomer or macromonomer. Controlled polymerization, with careful consideration of the amount of persistent radical present in the system can provide branched copolymers with differing topologies with degradable functionality within each branch.

The degradable functionality can also be incorporated in a difunctional monomer, such as a divinyl monomer and when the divinyl monomer is added at the end of a copolymerization reaction a multi-armed star or a network can be formed with the degradable functionality at each crosslink.

### EXAMPLES AND DISCUSSION OF EXAMPLES

### Example 1

### Degradable Linear (Homo)Polymers by ATRP/RROP Copolymerization

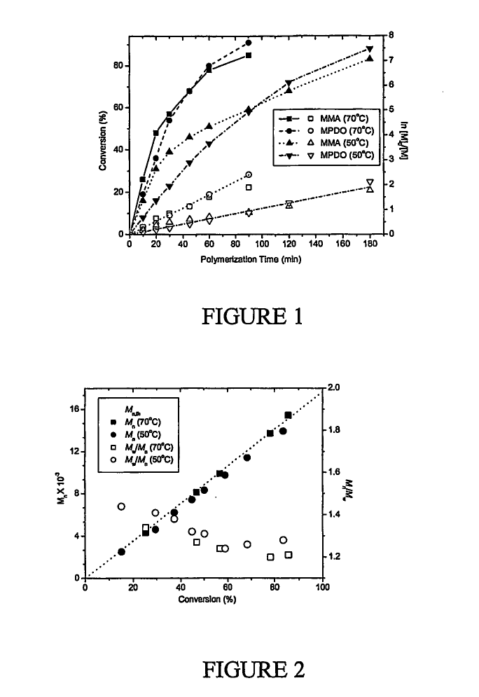

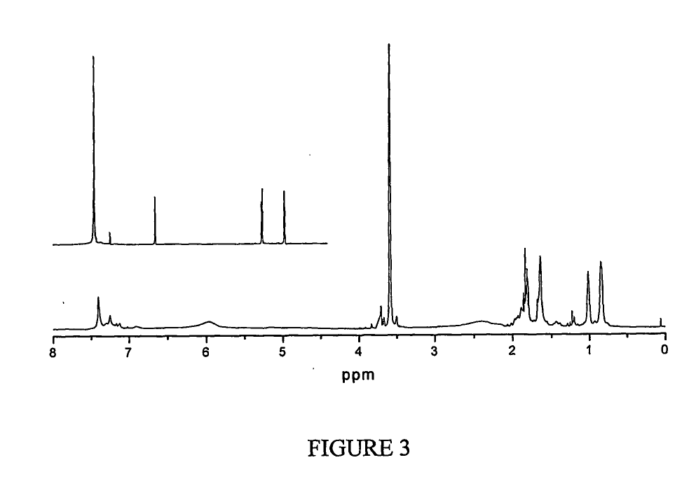

A degradable poly(methyl methacrylate), with low polydispersity index, was synthesized by copolymerization of methyl methacrylate (MMA) and 5-methylene-2-phenyl-1,3-dioxan-4-one (MPDO) by atom transfer radical polymerization (ATRP); FIG. 1. The number average molecular weights of the polymers measured by GPC matched well with the theoretical values (Mₙ≈15,000 g/mol), and the polydispersity indexes were in the range of M_{w}/Mₙ=1.2-1.3; FIG. 2. ¹H NMR data shows that MPDO is successfully incorporated into the copolymers with a completely ring-opened structure; FIG. 3. The linear semi-logarithmic kinetic plots for consumption of MPDO and MMA indicated a constant concentration of the growing radicals during the copolymerization and the rate of incorporation of MPDO and MMA into the copolymer was the same regardless of the polymerization temperature or monomer feed ratio, under typical ATRP conditions.

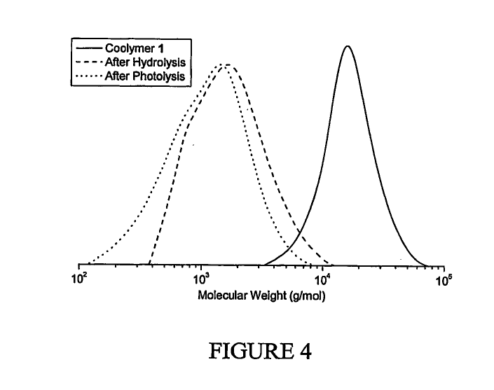

After either hydrolysis or photolysis of the copolymer, the molecular weight was reduced tenfold to Mₙ=1,620 g/mol and 1,480 g/mol, respectively, and polydispersity index was about 2, FIG. 4, which means that MPDO, with a ring-opened structure, is randomly incorporated into PMMA chain and that each incorporated MPDO monomer unit is responsive to photolytic or hydrolytic degradation. Polymers with a molecular weight of approximately 1,500 are expected to be processed and exuded from the body.

### a. Preparation of 5-Methylene-2-phenyl-1,3-dioxan-4-one (MDPO)

5-Methylene-2-phenyl-1,3-dioxan-4-one (MDPO) was prepared according to the previously reported method, [Bailey, W. J.; Feng, P. Z. Polym. Prepr. (Am. Chem. Soc., Div. Polym. Chem.) 1987, 28(1), 154.] with some modifications, (Scheme 4). The cyclic acrylate was synthesized by the reaction of β-chlorolactic acid with benzaldehyde in 45% yield, followed by dehydrochlorination with diisopropylamine in ether in almost quantitative yield. The monomer polymerized very rapidly when exposed to air because of its intrinsic reactivity. The polymerization runs were therefore carried out immediately after purification of the monomer.

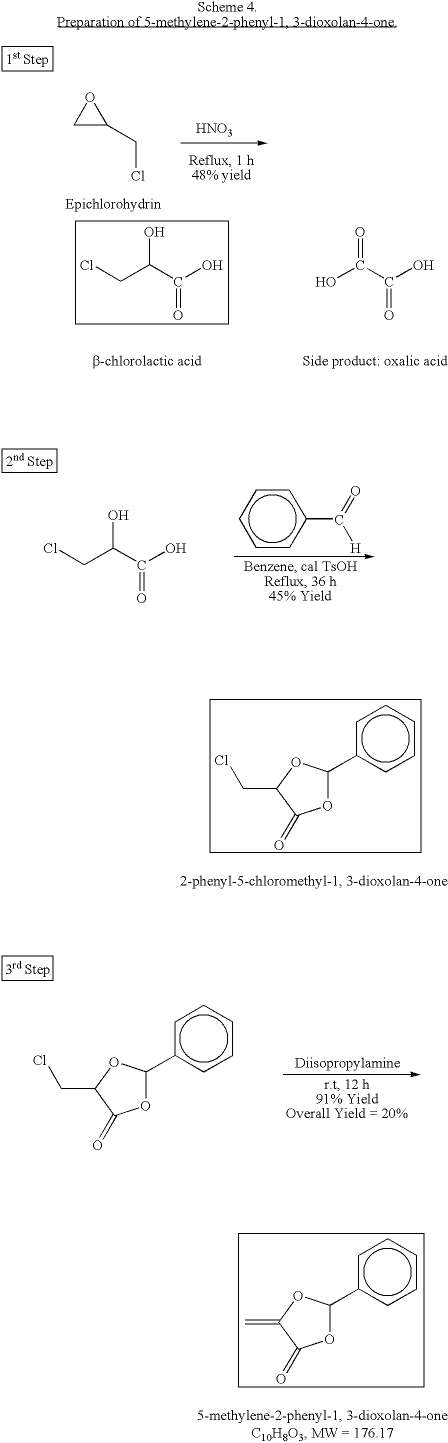

### b. Copolymerization of MPDO with MMA

The atom transfer radical copolymerization of MPDO with MMA was carried out in anisole using CuBr/CuBr₂/PMDETA (N,N,N′,N″,N″-pentamethyldiethylenetriamine) as a catalyst and ethyl 2-bromoisobutyrate as an initiator as shown in Scheme 5.

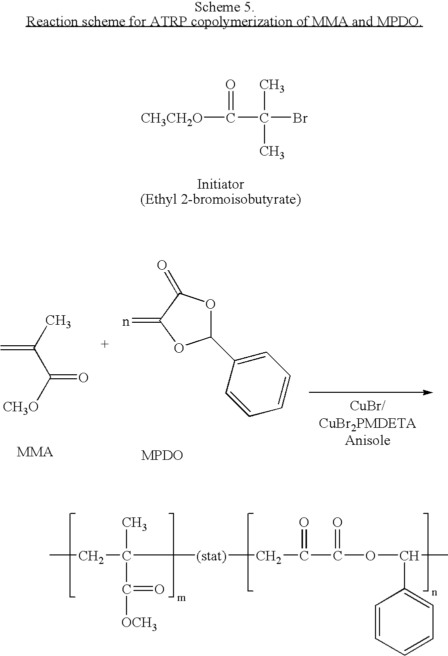

A typical procedure for copolymerization of MPDO with MMA follows: 14.3 mg of CuBr (0.10 mmol), 1.12 mg of CuBr₂ (0.005 mmol), 21.9 mg of PMDETA (0.105 mol), 0.264 g of MPDO (1.50 mmol), 1.50 g of MMA (15.0 mmol), and 2 mL of anisole were added into a 10 mL Schlenk flask. The flask was tightly sealed with a rubber septum and was cycled between vacuum and dry nitrogen three times to remove the oxygen. After the mixture was stirred at room temperature until it was homogeneous, the initiator, 14.7 μL of ethyl 2-bromoisobutyrate (0.10 mmol) was added, and the flask was immersed in an oil bath maintained at the desired temperature by a thermostat. At timed intervals, samples were withdrawn from the flask using degassed syringe in order to follow the kinetics of the copolymerization. The reaction conditions and the results of a series of copolymerization runs are listed in Table 1.

TABLE 1
The conditions and results for copolymerization of MPDO and MMA

| | Temp | Feed Ratio | Time | Conversion of | Conversion of | | | |
|---|---|---|---|---|---|---|---|---|
| Run | (° C.) | [MPDO]:[MMA] | (min) | MMA (%)^{d} | MPDO (%)^{d} | M_{n, th}^{e} | Mₙ (GPC)^{f} | PDI^{g} |
| 1^{a} | 90 | 1:10 | 30 | 88 | 89 | 15,760 | 15,730 | 1.24 |
| 2a^{a} | 70 | 1:10 | 90 | 85 | 91 | 15,360 | 15,420 | 1.21 |
| 2b^{b} | 70 | 1:5 | 90 | 83 | 88 | 14,260 | 13,930 | 1.28 |
| 2c^{c} | 70 | 1:3 | 90 | 81 | 86 | 15,790 | 16,810 | 1.31 |
| 3^{a} | 50 | 1:10 | 180 | 83 | 88 | 14,980 | 15,070 | 1.22 |

^{a}Reaction conditions: [I]₀/[CuBr]₀/[CuBr₂]₀/[PMDETA]₀/[MPDO]₀/[MMA]₀ = 1/1/0.05/1.05/15/150.
^{b}[I]₀/[CuBr]₀/[CuBr₂]₀/[PMDETA]₀/[MPDO]₀/[MMA]₀ = 1/1/0.05/1.05/25/125.
^{c}[I]₀/[CuBr]₀/[CuBr₂]₀/[PMDETA]₀/[MPDO]₀/[MMA]₀ = 1:1:0.05:1.05:40:120.
^{d}Measured by gas chromatography.
^{e}Theoretical number average molecular weight was calculated from the conversion of the monomers.
^{f}Determined by GPC using tetrahydrofuran as eluent with poly(methyl methacrylate) standards.
^{g}Polydispersity Index = M_{w}/Mₙ.

The first ATRP copolymerization of MPDO and MMA ([MPDO]:[MMA]=1:10) was carried out at 90° C. to produce poly(MDPO-co-MMA). Conversion of the two monomers almost reached 90% within 30 min. The number average molecular weight of the resulting poly (MDPO-co-MMA), measured by GPC was Mₙ=15,730 g/mol, which is well-matched with the theoretical value (M_{n,th}=15,760 g/mol), and the polydispersity index was M_{w}/Mₙ=1.24.

In order to investigate the “living” nature of the copolymerization and monomer conversion behavior, copolymerization ([MPDO]:[MMA]=1:10) was also carried out at 70° C. and 50° C. Reaction conversion was greater than 80% within 90 min at 70° C., and only required 180 min at 50° C. As shown in FIG. 1, plotting ln[M]₀/[M] against polymerization time afforded straight lines for both MPDO and MMA demonstrating the constant concentration of the growing radicals. The ratio of monomer consumption for MPDO and MMA is almost constant regardless of time, as is also shown in FIG. 1. The linear molecular weight-conversion profile (FIG. 2) indicates that that the molecular weight can be simply controlled by amount of added initiator, monomer(s) and polymerization time. The number average molecular weights of the resulting polymers, (Table 1, samples 2a and 3), measured by GPC are close to theoretical values, and the polydispersity indexes (PDI) are reasonably narrow (about 1.2). These results confirmed that the copolymerization of 10 mol % of MPDO with MMA is well-controlled under ATRP conditions.

The addition of higher levels of MPDO to the copolymerization would result in the preparation of polymers that would undergo a greater degree of fragmentation while the use of lower levels of MPDO would result in levels of fragmentation less than decimation. The copolymerization reactions were therefore also carried out with different ratios of MPDO and MMA. Conversion reached over 80% within 90 min at 70° C. regardless of the monomer ratio ([MPDO]:[MMA]=1:5 (Table 1 sample 2b) and 1:3 (Table 1 sample 2c)). The number average molecular weights of the resulting polymers were measured by GPC and were well-matched with theoretical values, and the PDI's were in the range of 1.2-1.3. The linear kinetic plots for consumption of monomers indicated a constant concentration of growing radicals, and the monomer consumption ratio of MPDO and MMA was similar regardless of the initial ratio of MPDO to MMA. The copolymers produced will undergo degradation into telechelic polymer fragments of predictable molecular weight the end functionality depending on mode of degradation.

The structure of the copolymer was examined by ¹H NMR spectroscopy (FIG. 3). ¹H NMR spectrum of MPDO monomer shows a peak at 6.6 ppm corresponding to the acetal proton, but this peak fully shifts to 5.9 ppm corresponding to a methine proton next to the ester oxygen of the ring-opened unit in the spectrum of the corresponding polymer, which means complete ring-opening of MPDO during the reaction. ¹H NMR spectrum of the polymer shows peaks at 7.4 ppm and 2.0-2.7 ppm corresponding to aromatic and aliphatic protons of the MPDO units, respectively. Also, it shows all of the peaks corresponding to the protons of MMA units. From the ¹H NMR measurement, it is confirmed that MPDO is successfully incorporated to the copolymer with a fully ring-opened structure. Further evidence for random incorporation of MPDO by ring-opening copolymerization was obtained by hydrolysis and photolysis of the polymer, FIG. 4.

### c. Degradation Studies

Kinetic studies on both the hydrolysis and photolysis reactions can be conducted in order to determine exactly the rate the different degradation reactions under a range of conditions.

To examine the copolymerization behavior and degradability of the copolymer, hydrolysis was carried out under basic conditions and photolysis by photo-irradiation, as shown in Scheme 6. After hydrolysis the molecular weight of the poly (MDPO-stat-MMA) of Example 16 was reduced to Mₙ=1,620 g/mol (about 10 time lower than the original polymer), with polydispersity index M_{w}/Mₙ=1.89; and after photolysis the copolymer provided polymer fragments with Mₙ=1,480 g/mol and polydispersity was 1.96 (FIG. 4).

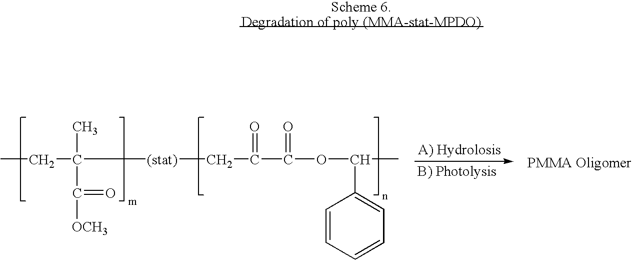

This means that MPDO with a ring-opened structure had been randomly incorporated into PMMA chain and that each MPDO monomer unit incorporated into the MMA chain provided an active site for degradation reactions.

c1. Photo-degradation. The irradiation was carried out with 2 w/v % anisole solution (solute, 100 mg; solvent, 5 mL) in UV chamber at 40° C. for 2 h.

c2. Hydro-degradation. The hydrolysis was carried out with potassium hydroxide (10 eq.) in 2 w/v % isopropanol/2-butanone (v/v=50/50) solution (solute, 100 mg; solvent, 5 mL) at 30° C. for 18 h.

These examples demonstrate that photo-(i.e. environmental) and hydrolytic-(i.e. a bio-) degradable PMMA copolymers with low polydispersity index can be synthesized by copolymerization of MMA and MPDO by ATRP. The rate of incorporation of MPDO and MMA into a copolymer was the same regardless of the polymerization temperature and monomer feed ratio under typical ATRP conditions; i.e. the level of incorporation of MPDO can be pre-selected by determining the desired ratio of comonomers and the final molecular weight of the copolymer can be pre-selected by the ratio of added initiator to monomer conversion. The molecular weight of the degraded polymer fragments are therefore a direct result of the level of MPDO initially added to the copolymerization and the final copolymer molecular weight.

Further, the rate of controlled copolymerization can be selected by reaction temperature and catalyst level/catalyst activity as detailed in a series of co-assigned U.S. Patents and Applications, U.S. Pat. Nos. 5,763,546; 5,807,937; 5,789,487; 5,945,491; 6,111,022; 6,121,371; 6,124,411; 6,162,882; 6,407,187; and U.S. patent application Ser. Nos. 09/018,554; 09/359,359; 09/359,591; 09/369,157; 09/534,827; 09/972,046; 09/972,056; 09/972,260; 10/034,908; and 10/098,052 all of which are herein incorporated by reference, and has been discussed in numerous publications by Matyjaszewski as co-author and reviewed in several publications. [Matyjaszewski, K., Editor; Controlled Radical Polymerization, ACS Symp. Ser., 1998; 685 1998, 483 pp.: Matyjaszewski, K. E., Editor; Controlled/Living Radical Polymerization. Progress in ATRP, NMP, and RAFT. ACS Symp. Ser., 768; 2000, 484 pp.; Matyjaszewski, K, Editor, Advances in Controlled Radical Polymerization. (Papers Presented at the 224th ACS National Meeting held 18-22 Aug. 2002 in Boston, Mass. ACS Symposium Series 2003, 854)]

Further, as exemplified in these cited applications, a full range of substituted (meth)acrylate and (meth)acrylamide monomers can be copolymerized by controlled radical polymerization processes. Therefore, while this example describes the preparation of a poly(methyl methacrylate) with dispersed degradable functionality randomly incorporated along the polymer backbone other (co)polymers with a wide range of functional substituents can be incorporated into a copolymer in addition to the incorporation of hydro-, photo-, and biologically degradable functionality.

### Example 2

### Synthesis of Degradable Polystyrene via CRP

The most obvious need for degradable polystyrene might be envisioned to be a photo-degradable polymer that would reduce the level/impact of foamed polystyrene packaging material in the visual environment However, the incorporation of photo-degradability into polystyrene was not sufficient to induce the market to move to such a material to reduce the litter problem in the mid-70's. The reason was that majority of the discarded material became dirty, ended up in the shade, or was partially buried; thereby reducing the level of incident light on the material and, hence, the degradability of the polymer. A degradable polystyrene, such as a material with dual degradation mechanisms, would circumvent this problem as the polymer would degrade in the sunlight or in shade.

While we will be describing the preparation of the target material by a CRP, exemplified by ATRP, any polymerization process can be employed if less control is acceptable, and indeed with the disclosure of a radically polymerizable comonomer comprising a precursor for a degradable functional group that forms a random copolymer or terpolymer with styrene, a standard free radical bulk copolymerization can form a dual mechanism degradable polystyrene.

a. Copolymerization of Styrene and MPDO

The ATRP copolymerization of MPDO and styrene ([MPDO]:[Sty]=1:10) was carried out at 110° C. following the conditions determined for the copolymerization of MPDO and MMA. After 30 min, conversion was 2% for styrene and 87% for MPDO respectively. The number average molecular weight of the resulting polymer, measured by GPC was Mₙ=2,070 g/mol, and the polydispersity index was M_{w}/Mₙ=1.14. This result implies that the control over the copolymerization by ATRP is good, but in the early stage of the copolymerization the resulting polymer mainly comprises units derived from MPDO. In the initial batch copolymerization of styrene and MPDO, styrene is not randomly incorporated in the polymer chain due to the large differences in reactivity ratios.

In order to synthesize a “uniformly” degradable polystyrene, i.e., where one desires that the degraded fragments would have a more uniform distribution of molecular weights, three alternative strategies were examined. Two of these strategies are exemplary of processes that can be employed where inherent comonomer reactivity ratio's do not allow random incorporation of the degradable comonomer(s) into the polymer, such as example 2a, and, if properly implemented, as taught below, each can lead to a more uniformly degradable material.

The first approach takes advantage of the high reactivity of a monomer exemplified by MPDO in styrene copolymerization, as noted above in example 2a. In this embodiment, adding a highly reactive monomer capable of forming a degradable unit in the polymer to an active controlled polymerization process. The addition may be continuous or intermittent Preferably, the molar amount of degradable monomer is sufficient to incorporate degradable monomer into each active polymer chain, for example, at least one mole of degradable monomer to one mole of initiator, more preferably, greater than 1.2 moles of degradable monomer or, for certain applications, greater than 1.5 moles of degradable monomer per mole of initiator. In this approach a small amount of MPDO is added periodically to a CRP of styrene and is almost immediately incorporated into the growing polymer chains. Actually, incorporation will not be instantaneous but would occur sufficiently rapidly that the concentration of MPDO would fall essentially to zero before the next addition. Multiple additions of MPDO will therefore result in multiple copolymer segments distributed along the polymer backbone interspersed with homopolymer segments. In this way the final polymer can be fragmented by activation of the functional units incorporated by the periodic radical ring opening copolymerization of MPDO by photo- or hydrolytic- or bio-degradation mechanisms. Nine equal additions of 1/9 mole fraction of the desired overall level of MPDO in the final polymer, at say 10%, 20%, 30% etc. of styrene conversion would lead to decimation of the molecular weight of the final copolymer after hydrolysis or photolysis. This approach can be applied to other radical copolymerization reactions, not just styrene, e.g. ethylene where a degradable low density film forming polymer would be formed. Such a polymer could find application as an agricultural film that would completely degrade whether above ground, photo-degradation, or below ground, bio or hydro-degradation.

The second approach is terpolymerization of styrene, MMA, and MPDO, example 2b below. With this approach one can expect more controlled incorporation of the degradable unit into the polymer backbone because of the much higher reactivity of MMA with an end unit comprising MPDO allowing greater incorporation of styrene, by reaction with the MMA end group, as a result of its presence at high concentration. In this embodiment, selecting comonomers displaying better cross propagation kinetics are selected for the terpolymerization reaction and take advantage of the high concentration of the predominant monomer in the reaction mixture and increase the concentration of this lower activity monomer in the resulting terpolymer.

The third approach is the preparation of a ring opening co-monomer that would be expected to have higher activity in a copolymerization with the specific targeted vinyl based comonomer, such as a substituted styrene. The RROP comonomer selected was 2-oxo-3-methylene-5-phenyl-1,4-dioxane (OMPD), example 4 below, which generates the same terminal radical species as does styrene during radical ring opening polymerization and would be expected to be randomly incorporated into a styrene backbone segment. This approach can also be implemented in non-controlled polymerization processes to prepare a degradable polymer with randomly distributed degradable functionality.

Therefore, all three approaches can be used to regularly incorporate the degradable functionality into a copolymer comprising any radically (co)polymerizable monomer, not only vinyl aromatic monomers, such as styrene, once consideration of the relative reactivity ratios of all (co)monomers are considered along with the sequence and/or periodicity of (co)monomer addition(s) to a batch copolymerization system.

b. Terpolymerization of Styrene, MMA, and MPDO.

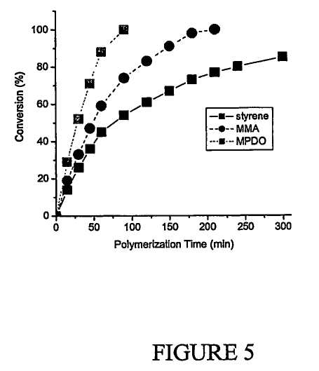

A terpolymerization approach is shown in Scheme 7. The terpolymerization was conducted using the following ratio of reagents. 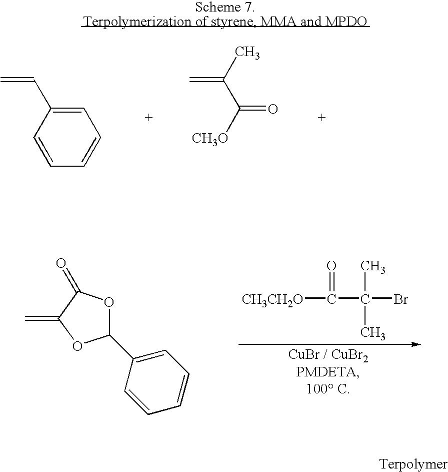
[I]:[CuBr]:[CuBr₂]:[PMDETA]:[St]:[MMA]:[MPDO]=1:1:0.05:1.05:150:15:15 (solvent=anisole). i.e., [St]:[MMA]:[MPDO]=10:1:1. The reaction was conducted at 100° C. The kinetics of the reaction showed a controlled polymerization and conversion of all monomers reached over 80% after 5 hours. The addition of an equimolar amount of MMA, (i.e., equimolar to MPDO) to the copolymerization of MPDO and styrene allowed significant incorporation of styrene into the copolymer, thereby improving the distribution of the incorporated of MPDO along the backbone copolymer chain, FIG. 5.

However, as also can be seen from FIG. 5 most of the MPDO had been incorporated into the copolymer when only a little more than 50% of the added styrene had been copolymerized leading to a gradient distribution of degradable functionality in the pure batch terpolymerization. A more random terpolymer, at higher styrene conversion, can be constructed by continuous, or periodic, addition of MPDO, and to a lesser extent MMA, to a batch copolymerization reaction so that a more constant ratio of reactive monomers is maintained throughout the copolymerization process thereby assuring a random distribution of comonomers along the polymer backbone and provision of a polymer with more uniform distribution of degradable links throughout the backbone. In this industrially simple procedure the continuous addition of MPDO and MMA comonomers to a batch controlled radical copolymerization of less active (co)monomer(s) maintains a uniform ratio of unreacted monomers in the system thereby forming a more uniform “random” distribution of one or more of the desired comonomers along the formed polymer backbone. This approach to comonomer distribution in a controlled radical (co)polymerization has been discussed earlier by one of the inventors; (Arehart, S. V.; Matyjaszewski, K Macromolecules 1999, 32, 2221).

### 3. Synthesis of 5,6-benzo-2-methylene-1,3-dioxepane and copolymerization with styrene

Another monomer, 5,6-benzo-2-methylene-1,3-dioxepane, was examined because of expected higher reactivity and greater extent of ring-opening compared to the other cyclic ketene acetals. All those properties were attributed to the driving force to form a stable benzyl radical and steric hindrance of seven-member ring to suppress the direct addition instead of ring opening. Although some work has been done in this field, no systematic study is carried out. The synthesis of the monomer follows:

### a. Synthesis of 2-(chloromethyl)-5,6-benzo-1,3-dioxepane

5 g (0.036 mol) 1,2-benzenedimethanol, 5.13 g (0.041 mol) chloroacetaldehyde dimethyl acetal and 100 mg (0.53 mmol) p-toluenesulfonic acid were mixed in the flask equipped with Vigreux column. The mixture was heated at 110° C. and the methanol was collected slowly over a period of 36 h. The product crystallized at room temperature and was dissolved in 50 mL benzene and washed with saturated NaHCO₃. After evaporating the solvent, the residue was recrystallized from cyclohexene at 6° C. to yield 5 g (70%) of colorless needles of 2-(chloromethyl)-5,6-benzo-1,3-dioxepane. 1H NMR (300 MHz, CDCl₃) δ 3.67 (d, 2H, CH₂Cl), 4.93(s, 4H, 2OCH₂), 5.07(t, 1H, OCHO), 7.23 (m, aromatic H).

### b. 5,6-Benzo-2-methylene-1,3-dioxepane

In a 50 mL flask, the t-BuOK was prepared by adding 0.5 g K into 20 mL t-butanol. Then 1.8 g (0.009 mol) of 2-(chloromethyl)-5,6-benzo-1,3-dioxepane in 5 mL benzene was introduced. The reaction was refluxed at 80° C. for 49 h under nitrogen atmosphere. The NMR showed that conversion is about 60%. After the addition of 100 ml of ether, the precipitate was removed by filtration and the solvents were removed by vacuum evaporation. The residue was vacuum distilled from metallic sodium under high vacuum. The NMR shows a very pure product was obtained. Copolymers of BMDO and styrene or MMA showed complete ring-opening and successful incorporation of BMDO into the copolymer, however, the dramatic difference of reactivity between the cyclic ketene acetal and those normal monomers prevented from the formation of random copolymer. BMDO was consumed much slower than other monomers. A terpolymer of MPDO and BMDO would form a copolymer with incorporated degradable units throughout the copolymer as a result of higher reactivity of MPDO and lower reactivity of BMDO.

### 4. Synthesis of 2-oxo-3-methylene-5-phenyl-1,4-dioxane (OMPD) and copolymerization with styrene

2-Oxo-3-methylene-5-phenyl-1,4-dioxane (OMPD) was successfully prepared from chloroacetaldehyde dimethyl acetal and styrene glycol as starting materials in a four step synthesis with an overall yield of 36%. The synthetic procedure is as follows:

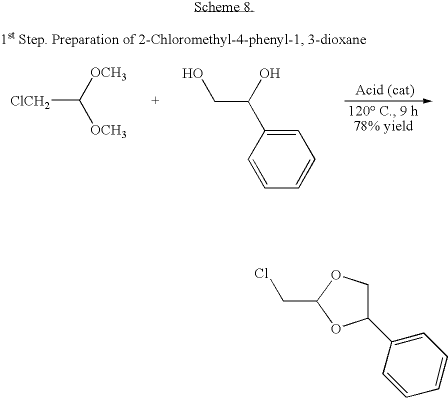

A mixture of 29.9 g (200 mmol) of chloroacetaldehyde dimethyl acetal and 27.6 g (200 mmol) of styrene glycol was heated at 120° C. with 0.25 g of Dowex 50 (H⁺) resin in a 100 mL round-bottomed flask. After the calculated amount of methanol had been collected by distillation (about 9 h), the crude product was distilled in vacuum to give colorless cis- and trans-2-chloromethyl-4-phenyl-1,3-dioxane (31 g, 156 mmol, 78.0% yield). (There was no reaction when styrene oxide was used instead styrene glycol).

2^{nd} Step. α-(Siloxy)-ethoxy nitrile: Addition of TMSCN

[Kirchmeyer, S.; Mertens, A.; Arvanaghi, M.; Olah, G A. Synthesis 1983, 498.]

This reaction is the key-step in the synthesis of OMPD. The reaction conditions have been optimized by examining several reaction conditions for the procedure. (Table 2)

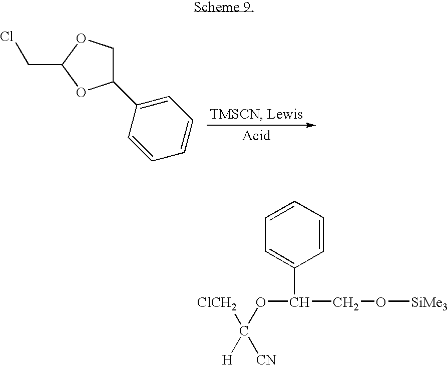

TABLE 2

| Lewis Acid | Temp. (° C.) | Time (h) | Yield (%) |
|---|---|---|---|
| ZnI₂ | 25 | 12 | 21 |
| ZnI₂ | 80 | 6 | Side reactions only |
| ZnCl₂ | 25 | 12 | 37 |
| AlCl₃ | 25 | 12 | 62 |

The nucleophilic displacement of an alkoxy group by trimethylsilyl cyanide, [trimethylsilyl cyanide is commercially available, but it is easily prepared from trimethylsilyl chloride and potassium cyanide in NMP (Rasmussen, J. K.; Heilmann, S. M. Synthesis 1979, 523)], is driven by the formation of the very strong Si—O bond (112 kcal/mol) compared with weaker Si—CN bond in trimethylsilyl cyanide. In this case, the chloromethyl group can trap the catalyst and lower the reactivity of the system; since an attack of the catalyst on the chloromethyl group is more favored than on the alkoxy group. When the reaction was conducted at relatively high temperature (80° C.) only side products were produced therefore lower temperatures are recommended. Use of a stronger Lewis acid led to a higher yield, aluminum chloride was the best Lewis acid examined and the yield was 62%.
Experimental Conditions: The Lewis acid catalyst (AlCl₃, 5 mg) was added under nitrogen to a mixture of 2-chloromethyl-4-phenyl-1,3-dioxane (9.93 g, 50.0 mmol) and trimethylsilyl cyanide (4.96 g, 50.0 mmol). The reaction mixture was stirred at room temperature for 12 h. After the reaction was complete the product were distilled under vacuum providing 9.24 g of α-(siloxy)-ethoxy nitrile (31.0 mmol, 62.0% yield). 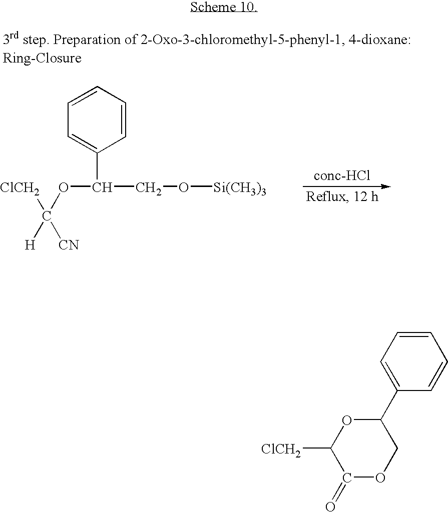
α-(Siloxy)-ethoxy nitrile (8.94 g, 30.0 mmol) and 6 mL of concentrated hydrochloric acid (37%) were refluxed for 1 h, then 30 mL of toluene was added to the flask and the mixture refluxed using Dean-Stark trap (c.a. 4 mL of water is obtained). After cooling the mixture was diluted with diethyl ether, washed with aqueous sodium hydrogen carbonate solution, and dried over anhydrous magnesium sulfate. The solvent was evaporated under vacuum to obtain the crude product (5.22 g, 23.0 mmol, 76.7% yield). 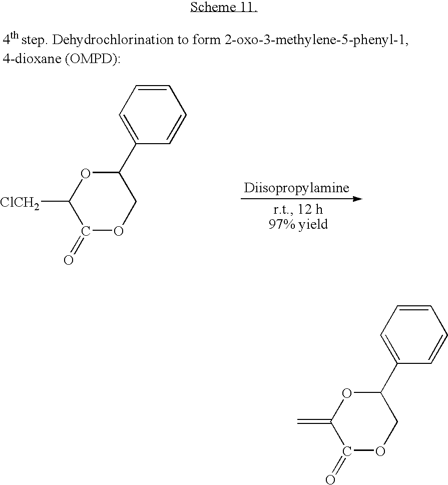
To a solution of 4.21 g (18.6 mmol) of 2-oxo-3-chloromethyl-5-phenyl-1,4-dioxane in 40 mL of diethyl ether, 2.87 mL (2.07 g, 20.5 mmol, 1.1 equivalents) of diisopropylamine was added slowly at room temperature under N₂. After the addition was completed, the reaction mixture was stirred at room temperature for 12 h. At the end of the reaction, diisopropylamine hydrochloride salts was precipitated. The reaction mixture was washed with deionized water, and the dichloromethane and excess diisopropylamine was removed by evaporation to give the pale yellow liquid product. (3.45 g, 18.1 mmol, 97.3% yield (crude)).

### e. Copolymerization of OMPD with Styrene: Preparation of Dual Mechanism Degradable Polystyrene by Direct Copolymerization

In the case of polymerization of 2-oxo-3-methylene-5-phenyl-1,4-dioxane (OMPD), the growing radical species, after radical ring opening addition of the monomer to the growing polymer chain, has a similar radical structure to styrene (Scheme 3). It is, therefore expected, that the copolymerization of styrene with OMPD would lead to the preparation of degradable polystyrene with a random distribution of the comonomer along the polymer backbone and an overall composition similar to the ratio of added comonomers. 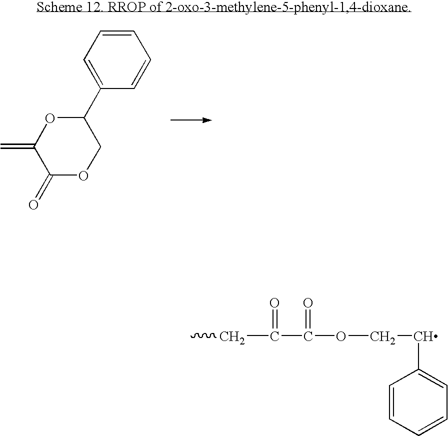
Note similar structure for the terminal radical present after the ring opening polymerization as present in the polymerization of styrene. In the six membered ring shown in scheme 2 this molecule has X, Y and Z=O; and R₁=H, R₂=phenyl and both R₃ and R₄, =H.

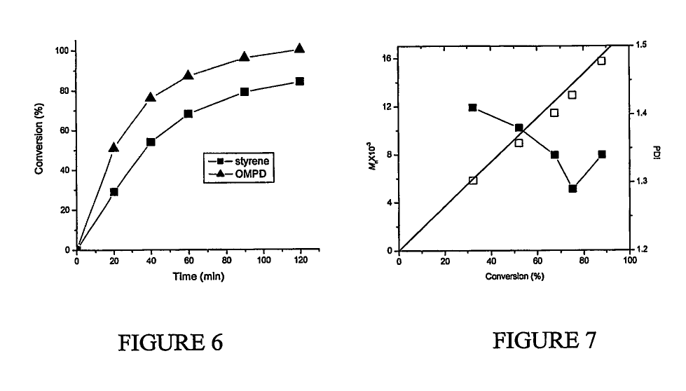

The ATRP copolymerization of OMPD and styrene ([OMPD]: [styrene]=1:10) was carried out at 110° C. to produce poly(styrene-co-OMPD) (Scheme 13). 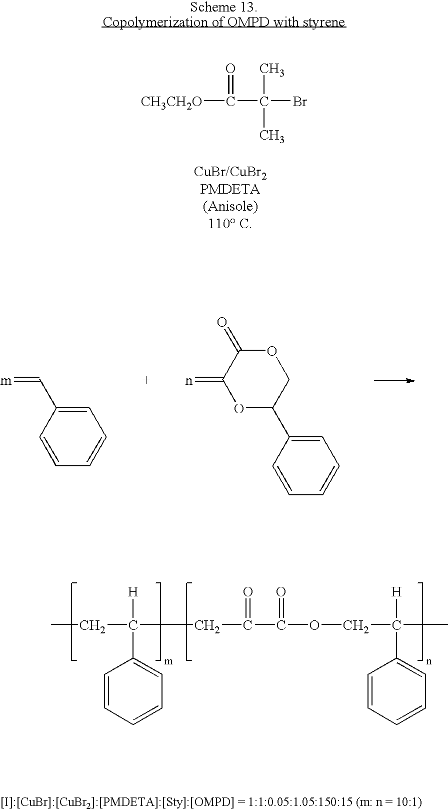
The copolymerization displayed a different behavior than that seen with the copolymerization of MPDO and styrene. (Example 2a) Conversion of styrene and OMPD was 84% and 100%, respectively, within 2 h. The number average molecular weight of the resulting copolymer, measured by GPC was Mₙ=15,720 g/mol, which matched the theoretical targeted value (M_{n,th}=15,960 g/mol), and the polydispersity index was M_{w}/Mₙ=1.34. The rates of monomer consumption for both OMPD and styrene are as shown in FIG. 6. The incorporation of styrene into the copolymer is greatly enhanced over that seen in example 2a and a degradable homopolymer was formed in a pure batch copolymerization reaction. The linear molecular weight-conversion profile (FIG. 7) indicates that that the molecular weight can be simply controlled by ratio of monomer to initiator and polymerization time, and the PDI's are reasonably narrow (about 1.3). The ratio of styrene to monomers, such as in the case, OMPD, may be varied to control the level of degradability in the final copolymer, for instance, greater levels of OMPD leads to greater fragmentation of the copolymer backbone.

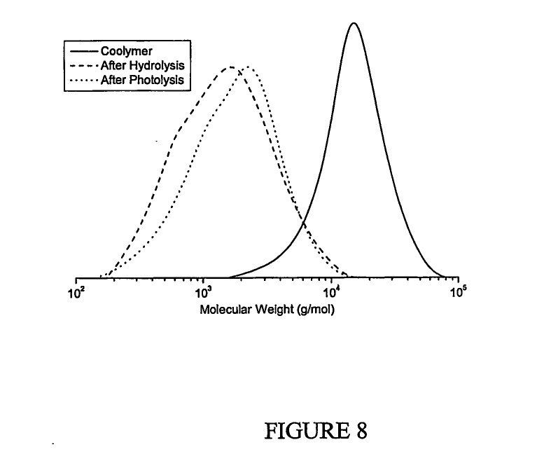

This copolymer was degraded hydrolytically with potassium hydroxide solution and photolytically, using UV light, resulting in polymer fragments 10 times and 7.5 times lower than the starting material respectively. FIG. 8)

New monomers for enhanced degradability can be designed and prepared, including one designed with a reactivity ratio closer to styrene and exemplified by incorporation into a degradable polystyrene. In order to increase the rate of degradability, of the final copolymer(s) two new monomers are proposed. A monomer with six-membered ring (Scheme 14) which can undergo RROP and insert degradable anhydride group, the anhydride group is also much more degradable than an isolated ester group, is another route to a more reactive degradable group. The monomer in Scheme 14 would provide a primary radical, which may be ideal for copolymerization with ethylene, and thereby provide material suitable for degradable agricultural films. The substituents on the 5-position could be selected to provide a chain end after RROP with reactivity closer to whichever (co)monomer(s) are being polymerized. A rout for synthesis of this monomer from dialky diglycollate and 1,3,5-trioxane is shown in Scheme 15.

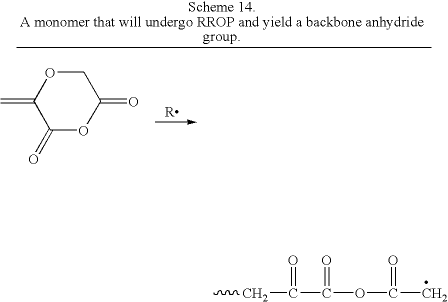

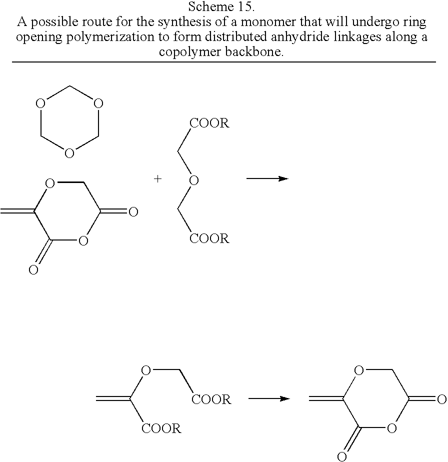

Another approach to a degradable polyethylene would be to use a dioxolan based RROP monomer in a direct copolymerization with ethylene under radical polymerization conditions since these monomers would be expected to behave in a similar manner to vinyl acetate in a copolymerization with ethylene, ethylene/vinyl acetate copolymers are commercial materials, or one could use vinyl acetate in a terpolymerization with the RROP and ethylene to attain different distribution of the degradable functionality along the backbone.

The discussion will now focus on copolymers that exemplify the preparation of materials demonstrating utility for bio-compatible and bio-degradable applications, i.e., materials incorporating monomers known to possess bio-compatibility: such as HEMA/RROP; and DMAA/RROP copolymerizations. The cited and incorporated technology have described examples that have examined direct incorporation of HEMA into a polymer backbone and incorporation of HEMA as HEMA-TMS. It is expected that the photo-, and hydrolytic-, or bio-degradable polymers formed by copolymerization of monomers, such as MPDO with HEMA (or HEMA-TMS) and DEMEMA, will have a random distribution of the photo- and bio-degradable links along the backbone because HEMA-TMS and DEMEMA have similar reactivity in ATRP copolymerizations to MMA. Therefore, these materials expand the scope of exemplified materials to include the synthesis of hydrophilic, biocompatible, and water-soluble degradable polymers. The target applications for this type of copolymer remain drug delivery and bio-compatible surfaces and/or implantable materials although water soluble block copolymers containing such monomers could also find application in water treatment.

The range of exemplified monomers can also be expanded to include a range of (meth)acrylamides whose (co)polymerization has also been described. One embodiment of the preparation of degradable (meth)acrylamides may be accomplished by copolymerization of MPDO with methyl acrylate and dimethyl acrylamide, optionally in a protected form as oxysuccinamide methacrylate.

Other bio-compatible degradable materials that can be prepared include HOPDMAA/RROP and PEO macromonomer copolymers/RROP. Of particular interest since the discovery of supersoft elastomers, co-pending U.S. Patent Application No. 60/402,279 would be crosslinked PEO brush copolymer systems comprising attached bio-active agents with tunable degradation rates. These soft materials could be implanted and both bio- and photo-induced degradation could be used for long term drug delivery by fragmentation of the “hairs” with attached functional materials from the matrix network.

Networks of differing controlled topology, incorporating any of the degradable polymer segments described above, will be formed by the preparation star copolymers followed by controlled cross-linking. Degradability can be incorporated into the arms of the stars or at the end of the copolymerization during the cross-linking reaction.

Since we have demonstrated the ability to regularly insert different degradable functionality into a polymer backbone the rate of photo and biodegradation in environments of differing pH's and define how to control it can further be controlled by modifying the substituents on the RROP monomer, e.g., R₁ and R₂ in the figures in scheme 2, additionally comprising degradable functionality, such as ethers and esters, in addition to examining heterocyclic monomers comprising other heterodative atoms.

Photodegradable materials suitable for use in microelectronics can also be prepared by applying the techniques disclosed herein. When targeting microelectronics high performance telecheleic oligomers can be linked via degradable segments. The materials can be spun on a substrate then selectively photo-degraded to provide a resistant pattern after washing the photo-degraded low molecular weight materials from the substrate.

A degradable polyethylene can be prepared by copolymerization or terpolymerization.

### Example 5

### Direct Incorporation of Captodative Monomers

a. Ethyl (1-ethoxycarbonyl)vinyl phosphate was prepared in 84% yield by treating ethyl bromopyruvate with trimethyl phosphite (Scheme 16). [Barton, D. H. R.; Chern, C. Y.; Jaszberenyi, J. C. Tetrahedron 1995, 51, 1867.]

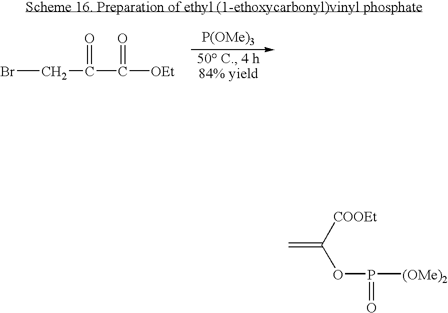

b. Ethyl α-trimethylsiloxyacrylate was prepared in 88% yield by a one-step procedure starting from methyl pyruvate and trimethylsilyl chloride (Scheme 17). [Creary, X.; Inocencio, P. A.; Underiner, T. L.; Kostromin, R. J. Org. Chem. 1985, 50, 1932.]

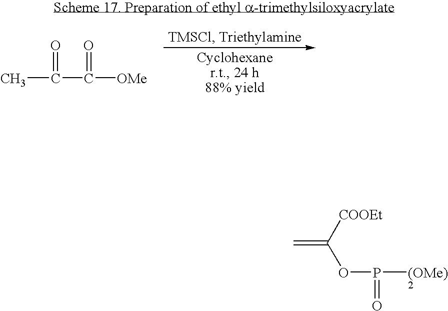

c. Polymerization:

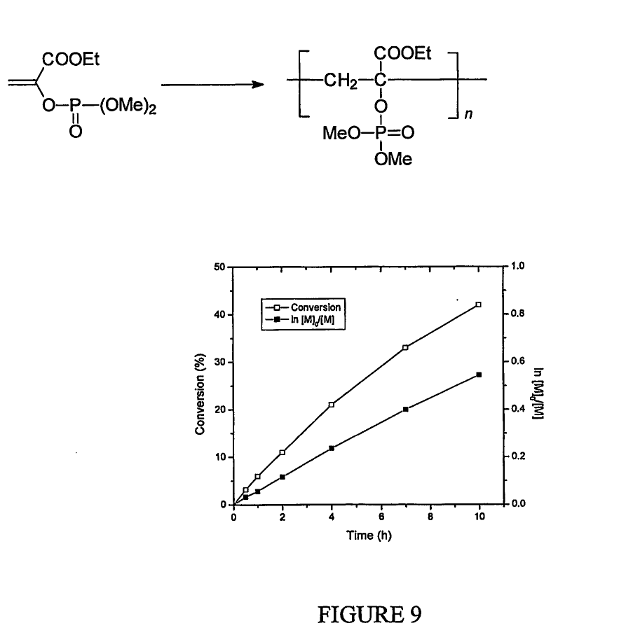

Initial experiments to conduct the polymerization of methyl α-trimethylsiloxyacrylate and dimethyl (1-ethoxycarbonyl)vinyl phosphate at 70° C. employed a standard ATRP method. The reaction conditions follow: Initiator is ethyl 2-bromoisobutyrate, catalyst is CuBr/CuBr₂(5%)/PMDETA. [Initiator]: [CuBr]: [CuBr₂]: [PMDETA]: [Monomer]=1:1:0.05:1.05:200. But methyl α-trimethylsiloxyacrylate and dimethyl (1-ethoxycarbonyl)vinyl phosphate both failed to polymerize (no polymerization after 12 h) with CuBr/PMDETA. We believed this failure was due to one of the characteristics of a highly reactive monomer, rapid formation of radicals followed by termination leading to oxidation of the catalyst. The polymerization was, therefore, carried out under other ATRP conditions more suited to the activity of the monomer; using tosyl chloride as an efficient initiator and CuCl/bipyridine as a less active catalyst. The reaction conditions follow: Initiator is tosyl chloride, catalyst is CuCl/CuCl₂(10%)/bypiridine. Polymerization Temperature: 70° C. [Initiator]:[CuCl]:[CuCl₂]: [bpy]:[Monomer]=1:0.5:0.05:1.5:200. The homopolymerization of α-trimethylsiloxyacrylate and dimethyl (1-ethoxycarbonyl)vinyl phosphate were carried out at 90° C. and produced the corresponding polymers. Conversion of monomers reached 77% and 42% after 10 h, respectively. (The rate of polymerization can be controlled by temperature and the amount of Cu(II).) Linear molecular weight-conversion profiles obtained for the polymerizations indicate that that the molecular weight can be simply controlled by polymerization time. The number average molecular weight of the resulting polymer is well-matched with the theoretical value, and the polydispersity index was M_{w}/Mₙ=1.3. These results showed that the polymerization of a (highly active) captodative monomer is possible under selected ATRP condition, i.e., using a good initiator and mild catalyst. FIG. 9 shows the results of controlled homopolymerization of ethyl (1-ethoxycarbonyl)vinyl phosphate and ethyl α-trimethylsiloxyacrylate using tosyl chloride as initiator) and CuCl/bypridine as a mild catalyst.

These polymers were used as macroinitiators for preparation of the block copolymers and random copolymers with ethyl (1-ethoxycarbonyl)vinyl phosphate and ethyl α-trimethylsiloxyacrylate segments with MMA as an exemplary monomer. Block copolymers were also prepared by conducting an ATRP of the captodative monomers from a preformed macroinitiator.

Both homopolymers and block copolymers were subjected to hydrolysis reactions.

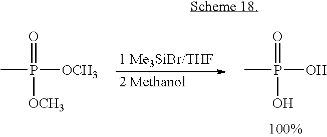

Comparison of 1H NMR spectra of before and after methanolysis of PP indicates that the reaction was successful. The peak at 3.8 ppm representing proton of (OCH₃)₂ disappeared without any change of other peaks.

Block copolymers comprising phosphoric acid segments and (meth)acrylates are of interest in composite formation, including bio-compatible composites and large scale commercial composites, such as concrete where these materials can act to modify the setting time of the material. The incorporation of degradable functionality will increase the utility of these bio-functional copolymers.

d. PMMA-P Block Copolymers

A PMMA was used as the macroinitiator to synthesize the block copolymer. The ratio of reagents used in the chain extension were [M]:[I]:[CuCl]:[bpy]=400:1:1:2 and the reaction temperature, T=70° C. GPC trace shows that the molecular weight progressively shifted from macroinitiator to the high molecular weight side. The initiation efficiency is satisfactory, however, there is a shoulder at the high MW because of the coupling. The compositions of the copolymers were calculated from the relative areas of peaks of the (OCH3) from PMMA to (OCH3)2 of PP in 1H NMR spectrum. The content of PP in the block copolymer is about 13 mol %. NMR spectra also show disappearance of the peak at 3.8 ppm assigned to proton of (OCH₃)₂ after methanolysis of the block copolymer using the same process as that for PP, indicating the methanolysis was successful. However, the peak at 4.2 ppm attributed to OCH₂ of PP segment also disappeared, which may be due to formation of micelles because CDCl₃ is a selective solvent for the PMMA block and nonsolvent for PP. After adding the nonselective solvent-THF, the OCH2 peaks appeared again, which proves formation of the micelles in CDCl₃.

Polymers that form micelles can be used directly in the delivery of drugs. Incorporation of degradable units would allow degradation of the micelle to exudable fragments after the delivery process has been completed.

e. Methanlolysis of poly P-styrene-P triblock copolymer

The procedure was the same as above. After methanolysis, the product cannot dissolve in CDCl3, which may be due to the composition of phosphoric acid group is too high in the block. Therefore, THF was used as the solvent for NMR analysis. Disappearance of the broad peak of proton of (OCH3) from PP indicates the successful reaction, although there is a sharp peak from THF solvent.

### 6. Incorporation of Degradable Links into the Initiator

a. Synthesis of bis(2-hydroxyethyl)disulfide diester of 2-bromoisobutyric acid (BHEDS(BiB)₂)

The disulfide link is biodegradable and the title compound was prepared and used as a difunctional initiator for the exemplary preparation of methacrylates with an internal disulfide link. In addition to providing biodegradability to a formed copolymer the disulfide link can be used directly for the modification of gold particles depositing on the surface initiator fragments. However, for the preparation of functional bio-responsive polymers with a degradable link DMAEMA or other well-defined methacrylates of limited molecular weight can be synthesized by ATRP. (See Scheme 19).

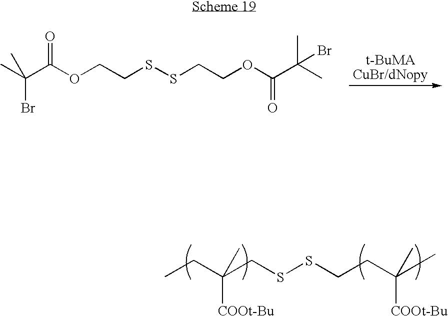

20.09 g (0.13 mol) of the alcohol was dissolved in 350 ml of THF. A solution of 43.4 g (0.26 mol) of 2-bromoisobutyric acid in 50 ml of THF was added and the solution was cooled in an ice-water bath. A solution of 53.65 g (0.26 mol) of DCC in 50 ml of THF was added upon stirring followed by a solution of 3.2 g of 4-DMAP in 50 ml of THF. The reaction mixture was kept in the ice-water bath for 5 minutes, and than for 18 hours at room temperature. The precipitated dicyclohexylcarbamide was filtered off and washed with 50 ml of THF on the filter. The solvent was evaporated, and the formed suspension was kept in refrigerator for several hours and then—at room temperature for 3 days. The impurities crystallized and were removed by filtration. The obtained viscous oil was analyzed by NMR. The following signals were observed (in ppm): 1.92 (s, 6H, (CH₃)₂C); 2.97 (t, 2H, CH₂S) and 4.40 (t, 2H, CH₂OOC). Approximately 2-3% of unreacted alcohol (the two methylene groups appear at 2.90 and 3.84 ppm) remained in the product. 1 ml of the oil weighs approximately 1.48 g.

b. Polymerization of t-butyl methacrylate initiated by BHEDS(BiB)₂ (nvt-tBuMA1)

In this preliminary experiment, 6 ml of t-BuMA was polymerized in the presence of 0.5 ml of phenyl ether, 0.0212 g CuBr (1/5 vs. Br from initiator), and 0.121 g of dNbpy at 80° C. To the clear brown solution, 110 μl of the initiator was added. The polymerization was carried out for 40 min. The conversion was 34.2%, Mn=6240 g/mol, PDI=1.16.

c. Solution polymerization of t-butyl methacrylate initiated by BEDS(BiB)₂ (nvt-tBuMA4)

Several exploratory runs were conducted in order to define conditions for a well-controlled reaction. This was attained when the reaction was performed in the presence of a solvent order to slow down the polymerization (in comparison with the previous bulk polymerization experiments) and suppress undesired coupling reactions. For the same reason, Cu(II) was added to the polymerizing mixture. The temperature was also decreased (60° C. vs. 80° C. in the scoping reactions).

Reaction Conditions: 0.0125 g (95% of the total Cu) and 0.0010 g of CuBr₂ and 0.0287 g of bpy were dissolved in a well-degassed (5 f-p-t cycles) mixture of 3 ml of tBuMA and 3 ml of butanone, containing 0.5 ml of diphenyl ether as internal standard for GC measurements. 28 μl of the bromoisobutyrate disulfide initiator was injected to the solution and the reaction was carried out at 60° C. The results are presented in Table 3.

TABLE 3

| Sample | Time, min | Conversion (GC) | Mn, kg/mol | PDI |
|---|---|---|---|---|
| 1 | 20 | 0.034 | 5.15 | 1.32 |
| 2 | 40 | 0.275 | 9.84 | 1.28 |
| 3 | 70 | 0.371 | 13.37 | 1.25 |
| 4 | 100 | 0.363 | 13.65 | 1.26 |
| 5 | 140 (slightly | 0.36 | 15.02 | 1.21 |
| | brownish-green) | | | |

d. Solution Polymerization of t-butyl Acrylate Initiated by BHEDS(BP)₂ (nvt-tBuA1)

A hyperbranched polymer with well-defined branches further possessing degradable thioester links could be prepared using t-butyl acrylate instead of the methacrylate as the monomer. Therefore, the polymerization of this monomer was studied. Reagents t-BuA-3 mL (20.7 mmol), Ph₂O-3 mL, CuBr-0.0059 g (1/5 vs. Br), PMDETA-9 μL, BHEDS(BP)₂-38 μL (0.1035 mmol). Reaction temperature T=80° C.

The mixture of monomer and solvent was degassed well by 5 f-pt cycles. CuBr was then added followed by the ligand. When a homogeneous solution was formed, the flask was heated in an oil bath and the initiator was injected. The results are shown in Table 4.

TABLE 4

| Sample | Time, min | Conversion (GC) | Mn, kg/mol | PDI |
|---|---|---|---|---|
| 1 | 20 | 0.054 | 2.40 | 1.91 |
| 2 | 60 | 0.079 | 2.98 | 1.66 |
| 3 | 110 | 0.127 | 3.43 | 1.57 |
| 4 | 220 | 0.236 | 3.55 | 1.55 |
| 5 | 510 | 0.307 | 4.97 | 1.40 |
| 6 | 1320 | 0.421 | 8.46 | 1.24 |

As seen from the results presented above, the reaction reaches higher conversion, which could be further improved by changing the amount of catalyst and addition of deactivator. However, from the analysis of SEC curves (showing tailing towards the low molar mass region) it seems that transfer reactions are more significant than in the case of tBuMA.

### 7. ATRP of Methacrylates Using Disulfide-Based Initiator

In example 6, polymerizations of methacrylates and acrylates using disulfide-based ATRP initiator. In order to increase the rate of deactivation over example 6, a co-solvent, acetone, was used in order to increase the solubility of the cupric/bpy complex in the reaction medium. The reactions were carried out at 50° C. (lower than in the previous reactions). All reactions proceeded to high conversions.

a. ATRP of MMA using the bis(2-bromoisobutyrate) ester of bis(2-hydroxyethyl)disulfide, BHEDS(BiB)2 (nvt-MMAS1 and nvt-MMAS2)

The new conditions were examined for the polymerization of MMA. Conditions were changed as outlined above. MMA was chosen, since the resulting polymers could be analyzed by GPC using pMMA standards. Two reactions were carried out at identical conditions to check for reproducibility.

MMA-5 mL (0.0467 mol); Acetone-2 mL, DPE-0.2 mL; CuBr-0.0334 g (0.233 mmol); Bpy-0.0728 g (0.466 mmol); BHEDS(BiB)2-50 μL (0.1168 mol; 1/400 vs. monomer). Reaction temperature, T=50° C.

The monomer, phenyl ether and the solvent were mixed and degassed by 5 (in the first experiment) or 7 (in the second experiment) freeze-pump-thaw cycles. The catalyst was added to the frozen mixture, the Schlenk tube was closed with a glass stopper, and evacuated and back-filled with nitrogen 4-5 times. The mixture was then heated to 50° C. A brown solution was formed containing small amount of insoluble complex. The well-deoxygenated (by purging with nitrogen) initiator was then injected. The results are presented in Tables 5 and 6.

TABLE 5
Experiment nvt-MMAS1

| Sample | Time, min | Conv. (GC) | Mn, g/mol | PDI |
|---|---|---|---|---|
| 1 | 40 | 0.134 | 7600 | 1.28 |
| 2 | 85 (green precip.) | 0.360 | 15200 | 1.32 |
| 3 | 140 | 0.435 | 26300 | 1.33 |

TABLE 6
Experiment nvt-MMAS2

| Sample | Time, min | Conv. (GC) | Mn, g/mol | PDI |
|---|---|---|---|---|
| 1 | 30 | 0.111 | 7950 | 1.28 |
| 2 | 65 | 0.188 | 13700 | 1.35 |
| 3 | 100 | 0.279 | 17400 | 1.36 |
| 4 | 150 | 0.505 | 19000 | 1.35 |
| 5 | 215 | 0.615 | 22100 | 1.36 |
| 6 | 300 | 0.835 | 25600 | 1.40 |

It is seen that molecular weights increase with conversion. The GPC traces were symmetrical. After approximately 1 hour, the mixtures became heterogeneous and green Cu(II) complex partially precipitated, but the homogeneous part of the mixtures was still brown.

b. ATRP of tBuMA using the bis(2-bromoisobutyrate) ester of bis(2-hydroxyethyl)disulfide, BHEDS(BiB)2 (nvt-tBuMAinacetoneS1 and nvt-tBuMAinacetoneS2)

Once the polymerization conditions for MMA were found, the ATRP of t-BuMA was also attempted. Two reactions were run: in the first, the same ratios of the reagents as in the MMA polymerizations were used, and in the second, the amount of acetone was slightly increased, and two fold lower DP was targeted. In both cases, well-controlled polymerizations were achieved.

tBuMA-5 mL (0.0308 mol); Acetone-2 mL (in experiment #1) or 3 mL (in experiment #2), DPE-0.2 mL; CuBr-0.0221 g (0.154 mmol; in experiment #1) or 0.0442 g (in experiment #2); Bpy-0.0482 g (in experiment #1) or 0.0962 g (in experiment #2) BHEDS(BiB)₂-32 μL (0.077 mol; 1/400 vs. monomer; experiment #1) or 64 μL (experiment #2). Reaction temperature, T=50° C.

The monomer, phenyl ether, and the solvent were mixed and degassed by 6 freeze-pump-thaw cycles. The catalyst was added over the frozen mixture, the Schlenk tube was closed, and evacuated and back-filled with nitrogen 4-5 times. The mixture was then heated to 50° C. A brown solution was formed containing small amount of insoluble complex. The well-deoxygenated (by purging with nitrogen) initiator was then injected. The results are presented in Tables 7 and 8.

TABLE 7
Experiment nvt-tBuMASin acetone 1

| Sample | Time, min | Conv. (GC) | Mn, g/mol | PDI |
|---|---|---|---|---|
| 1 | 30 | 0.012 | 4950 | 1.34 |
| 2 | 65 | 0.115 | 9100 | 1.39 |
| 3 | 110 | 0.140 | 13600 | 1.43 |
| 4 | 160 | 0.226 | 16800 | 1.44 |
| 5 | 220 | 0.500 | 19400 | 1.43 |
| 6 | 300 | 0.423? | 25200 | 1.46 |

TABLE 8
Experiment nvt-tBuMASin acetone2

| Sample | Time, min | Conv. (GC) | Mn, g/mol | PDI |
|---|---|---|---|---|
| 1 | 30 | 0.061 | 4900 | 1.29 |
| 2 | 70 | 0.222 | 8500 | 1.32 |
| 3 | 120 (green precip. | 0.442 | 11700 | 1.36 |
| | but brown soln.) | | | |
| 4 | 210 | 0.691 | 18200 | 1.35 |
| 5 | 285 | 0.848 | 19500 | 1.41 |
| 6 | 345 | 0.874 | 21700 | 1.35 |

Although the polydispersity was somewhat high, the GPC traces of the polymers were symmetrical and no significant tailing was observed. Thus, the controlled polymerization of tBuMA was achieved. A kinetic plot and evolution of Mn with conversion displayed linear semilogarithmic kinetics.

### 8. Reduction of the Disulfide Bond in the Methacrylate Polymers

In order to demonstrate that the incorporated dithio link remains degradable under reducing conditions a series of reducing agents were evaluated. The reducing agent initially used with polystyrene, in a series of experiments, dithiothreitol (DM, was found not suitable for the cleavage of the disulfide bond in the methacrylate polymers since it can react with the ester groups. In addition, DTT reacts slowly with disulfides (50 hour reactions were carried out previously) and it was desirable to find a more efficient reducing agent, which cannot affect ester groups. Another reducing agent, triphenylphosphine was tested (it was already known from experiments with disulfide-containing polystyrene that this reagent cleaves disulfide bonds). It was efficient, but reactions were relatively slow. According to literature, the most efficient reducing agent for aliphatic disulfides seems to be tributylphosphine, which in the presence of small amounts of water converts very rapidly disulfides to thiols:
RS−SR+Bu₃P+H₂O→2R−SH+Bu₃P=O

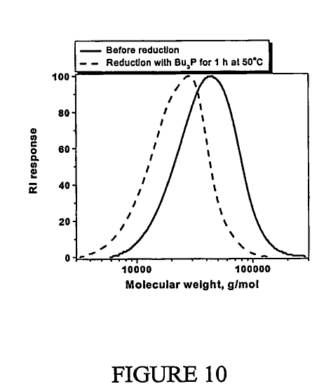

0.04 g of the final pMMAS2 was dissolved in 1 mL of DMF, and 0.1 mL of water and 0.05 mL of diphenylether were added. (To redissolve the precipitated polymer, slight heating is necessary.) Nitrogen was bubbled through the mixture for 2 hours. Then, 0.2 mL of tributylphosphine (also bubbled with nitrogen for 2 h) was added and the emulsion-like reaction mixture was kept at 50° C. for 1 hour. Two samples were then taken and one of them was diluted with 50 mM LiBr in DMF (analyzed by DMF GPC) and the other—with THF (it was analyzed in the THF line GPC). It was observed (see FIG. 10) that the polymer was completely cleaved at these conditions—no unreacted disulfide could be seen. (In fact, a first sample was taken immediately after injection of the tributylphosphine and analyzed and even it was already bimodal, showing significant cleavage if the disulfide after just several minutes.)

The same reaction can be performed with poly(t-butyl methacrylate) with internal disulfide bond and when the degraded thio-terminated product is heated for several hours the thiol group can react with the ester groups, thus yielding a hyperbranched polymer.

### 9. Preparation of α,ω-dimercaptopolystyrene and coupling the products

In order to demonstrate that the tele-functional di-thio or dimercapto polymers formed above could be reversible coupled thereby forming high molecular weight polymers from the degraded fragments several samples of dibromo-terminated polystyrene were prepared (pStyBr2-1 with Mn=24 kg/mol, PDI=1.13; pStyBr2-2 with Mn=37 kg/mol, PDI=1.14, and pStyBr2-3 with Mn=85 kg/mol and PDI=1.34). The bromine end-groups were transformed into thiol-groups, but in order to obtain a mixture of “monomer” and its coupling products directly, oxygen was not removed from the reaction mixtures. The procedures were carried out for shorter times.

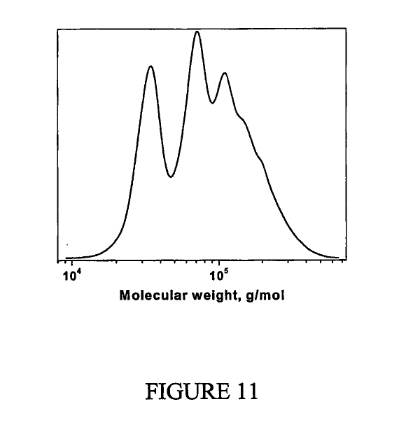

0.8 g of pStyBr2-1 (or 1.2 g of pStyBr2-2) was dissolved in 5 ml of TDMF and the formed solution (heating for ca. 20 minutes to dissolve the polymer) was heated to 80° C. for 8 h. 3 mL of methanol was added slowly (1 mL every 10 minutes) and the solution was kept at the same temperature for additional 2 h. The formed product was precipitated in methanol and analyzed. When the higher molecular weight polymer (pStyBr2-3) was used 1.4 g was dissolved 5 mL of TDMF and 3 mL of methanol were added, i.e., the concentration of the bromine groups was two times lower). A typical GPC trace of the product of the in situ oxidation of the thiol obtained from pStyBr2-2 is shown in FIG. 11—as seen coupling products up to pentamers can be observed.

### 10. Coupling Reactions

Other approaches to coupling polymers that can incorporate degradable functionality into the resulting copolymer were also examined. In the following examples the terminal functionality on a growing ATRP chain was used to from higher molecular weight polymerized polymeric materials. This approach allows direct use of a telechelic polymer formed by ATRP in an ATRC reaction. It provides the benefit of forming materials with low residual halogen content which could be advantageous for subcutaneous, intraperitoneal, or intravenous administration. An ATRC reaction can be driven to completion by use of a transition metal in a lower oxidation state, such as zero oxidation state, or by other reducing agents such as ascorbic acid or tin octanoate.

Materials. Styrene (Acros, 99%/0) was distilled under reduced pressure (65° C./35 mmHg). CuBr (Acros, 99%) was purified using a previously reported procedure. [Keller, R. N.; Wycoff, H. D. Inorg. Synth. 1946, 2, 1.] Toluene (Fisher, 99.8%) was distilled and stored under nitrogen. 1,1,1-tris-(4-(2-Bromoiso-butyryloxy)phenyl)ethane (3-BrⁱBu) and pentaerythritol tetrakis(2-bromoisobutyrate (4-BrⁱBu) were synthesized according to literature procedure. [Matyjaszewski, K.; Miller, P. J.; Pyun, J.; Kickelbick, G.; Diamanti, S. Macromolecules 1999, 32, 6526.] Unless specified, all other reagents were purchased from commercial sources and used without further purification.

Polymerization Procedures. The ATRP of St was carried out at 90° C., using a procedure adapted from literature. [Matyjaszewski, K.; Patten, T. E.; Xia, J. J. Amer. Chem. Soc. 1997, 119, 674]. The monofunctional initiator was introduced into the reaction either in one step or two steps, at the beginning and after a certain reaction time. When mixtures of mono and multifunctional initiators were employed, they were introduced either at the same time or at different reaction times.

Coupling Reactions. A Schlenk flask was charged with 0.71 g (2.15×10⁻⁴ mol) of polystyrene, synthesized as previously described, and 0.0078 g (5.38×10⁻⁵ mol) of CuBr. After it was vacuumed and backfilled with nitrogen, 3 ml (5.38×10⁻⁵ mol) of toluene was added. When the polymer was completely dissolved, 0.011 ml of (N,N,N′,N″,N″-pentamethyldiethylenetriamine (PMDETA) followed by ascorbic acid (0.04 g; 2.15×10⁻⁴ mol) were introduced, and three thaw-freeze cycles were performed. The flask was than placed on an oil bath and stirred at 90° C. The molecular weight of the polymer doubled. When a difunctional polystyrene was used in the reaction the molecular weight increased from 2600 to 18,700; a seven fold increase in molecular weight.

Analysis. Conversions were determined using a Shimadzu GC-17 gas chromatograph, while molecular weights were measured on a Waters GPC, against polystyrene standards.

Assisted Coupling of (Co)Poly(Meth)Acrylates.

Coupling of oligo/polystyrene units has been described in the cited references. The first hydroxyl-functionalized PMA was synthesized using as initiator 2,2-dimethyl-3-hydroxypropyl α-bromoisobutyrate. A high purity of this initiator was confirmed by NMR. NMR was also used to confirm the purity of the PMA precursor. Initial attempts at coupling the PMA showed an incomplete reaction, or even no coupling was observed. Therefore, a strategy for coupling PMA was developed. This involved the addition of certain amounts of styrene to the reaction medium, in order to obtain efficient coupling after the insertion of styrene into the terminus of the growing polymeric chain. The experiments showed that the best coupling was obtained with a ratio [St]/[PMA]=1. An increase of this ratio led to a broader molecular weight distribution of the coupled product, while a decrease to 0.5 led to an incomplete coupling.

Iron is a more environmentally benign transition metal and iron zero was demonstrated to be an efficient coupling agent

a. Identification of catalysts for coupling of mono-bromo-meth)acrylate using styrene as coupling moderator.

a1. Use of cyclam as ligand.

Run DHOMA-4. Ratio of reagents: CuBr/HOMA-2₁₆₆₀/Cy/St/Cu⁰=1/1/2/5/4; CuBr=0.043 g (3*10⁻⁴ mol); C=0.12 g (6*10⁻⁴ mol); toluene=1.5 ml; HOMA-2₁₆₆₀=0.5 g (3*10⁻⁴ mol) (2 ml soln. of 3.5 g polym/14 ml); Cu⁰=0.076 g (12*10⁻⁴ mol); St=0.17 ml 0.16 g=15*10⁻⁴ mol). Reaction temperature, 70° C. The change in the molecular weight of the polymer was followed by GPC and it could be seen that the use of styrene as capping/coupling aid showed that the principle works, but it should be improved, in order to get better quality of coupling.

a2. Use of PMDETA as ligand.

Run DHOMA-5. Ratio of reagents: CuBr/HOMA-2₁₆₆₀/PMDETA/St/Cu⁰=1/1/2/5/4. CuBr=0.043 g (3*10⁻⁴ mol); PMDETA=0.125 ml (0.104 g=6*10⁻⁴ mol); toluene=1.5 ml; HOMA-2₁₆₆₀=0.5 g (3*10⁻⁴ mol) (2 ml soln. of 3.5 g polym/14 ml); Cu⁰=0.076 g (12*10⁻⁴ mol); St=0.17 ml (0.16 g=15*10⁻⁴ mol); reaction temperature 70° C. The efficiency of the coupling reaction was much higher than the previous coupling reaction.

a3. Use of PMDETA as ligand with lower levels of styrene.

Run DHOMA-6. Ratio of reagents: CuBr/HOMA-2₁₆₆₀/PMDETA/St/Cu⁰=1/1/2/2/4; CuBr=0.043 g (3*10⁻⁴ mol); PMDETA=0.125 ml (0.104 g=6*10⁻⁴ mol); toluene=1.5 ml; HOMA-2₁₆₆₀=0.5 g (3*10⁻⁴ mol) (2 ml soln. of 3.5 g polym/14 ml); Cu⁰=0.076 g (12*10⁻⁴ mol); St=0.07 ml (0.063 g=6*10⁻⁴ mol); reaction temperature 70° C. Coupling occurred, see FIG. 8, and indeed the use of lower concentration of styrene brought about a small improvement in coupling results, i.e., the shoulder at higher MW is smaller. However, there is still there is some unreacted precursor, probably due to low chain end functionality.

### 11. Coupling of Hydroxyl-Functional Poly(Meth)Acrylates

A further sample of HO-(PMA), or HOMA, was synthesized with Mn=2300 and PDI=1.11. 4.14 grams were isolated, and used in the following coupling experiments.

a. [PMA→Sty→coupling]. The goal is to produce a fully coupled product Use of molar ratios 1 MA to 1.5 Sty and 4 Cu⁰ in a coupling experiment provided a GPC traces that showed change of Mn from 2,300 to 4,700.

b. Coupling of hydroxy-terminated PMMA using MA and styrene as capping/coupling agents. [MMA→MA→Sty→Coupling].

The MW of the first MMA polymer was 6,000 and was unchanged after the capping addition of MA. This product was isolated and dried, then new ATRP components were added along with Sty and the coupling continued. The Mn increased to 11,800.

c. Coupling Higher Molecular Weight Polymers.

Run DHOMA-7. Ratio of reagents: CuBr/ANHOMA₄₃₈₀/PMDETA/St/Cu⁰=1/1/2/1/4; CuBr=0.043 g (3*10⁻⁴ mol); PMDETA=0.125 ml (0.104 g=6*10⁻⁴ mol); ANHOMA₄₃₈₀=1.32 g (3*10⁻⁴ mol) (6.8 ml soln. of 3.9 g polym/20 ml); Cu⁰=0.076 g (12*10⁻⁴ mol); St=0.035 ml (0.0315 g=3*10⁻⁴ mol); reaction temperature 70° C. The results shown that the coupling of bromine functionalized PMA can be achieved with good results by adding a small amount of St as a coupling agent in the ATRC. The best results were obtained when the ratio PMA/St was 1.

### 12. Coupling reactions of PStBr using Fe⁰

The following experiment is one of a series of experiments that were run in order to check the feasibility of using Fe⁰ instead of Cu⁰ since iron forms complexes with lower color and are perceived to be more environmentally benign.

Ratio of reagents: CuBr/BrPST₃₈₄₀Br/PMDETA/Fe⁰=1/0.5/1/2; CuBr=0.03 g (2.08*10⁻⁴ mol); PMDETA=0.045 ml (0.36 g=2.08*10⁻⁴ mol); toluene=5 ml; BrPST₃₈₄₀Br=0.4 g (1.04*10⁻⁴ mol) (G2ST-2); Fe⁰=0.0233 g (4.16*10⁻⁴ mol).

This experiment was run using a micron size iron and the extent of coupling was acceptable with a clear increase in the molecular weight to a multi-coupled polymer with a peak height at 81,140. (A 21 fold increase in molecular weight)

### 13. Incorporation of Degradable Functionality into the ATRP Initiator

In order to exemplify this concept a difunctional EG-based bromoisobutyrate was prepared from ethylene glycol, using the dicyclohexyl dicarbodiimide (DCC) technique. The NMR spectrum indicates a high purity initiator Br—C—(CH₃)₂—CO—O—CH₂—CH₂—O—CO—C—(CH₃)₂—Br. The difunctional initiator was further used in ATRP of styrene. Thus, an experiment run in the following reaction conditions: ST/CuBr/CuBr₂/BrEGBr/PMDETA=100/1/0.05/1/1.05, at 80° C., showed a linear semilogarithmic kinetic plot, as well as a linear increase of molecular weights with conversion. GPC showed a clean shift of molecular weight to higher molecular weights and a low PDI (1.13). The polymer was used as starting material in an ATRC, under the following reaction conditions: CuBr/BrPST₆₉₄₀Br/PMDETA/Cu⁰=1/0.5/2/2; T=70° C.; solvent toluene (20% wt). The ATRC led to the formation of a polymer with high molecular weight and evenly distributed degradable segments along the polymer backbone.

### 14. Incorporation of Macro-Degradable Links in an Initiator for ATRP

The incorporation of degradable polymer segments into an ABₙ block copolymer can accomplish two different tasks. One is to provide degradability in the target environment and the other is to provide material properties that are compatible with delivery to that environment, or residence in that environment, prior to degradation. This approach to environmentally compatible degradable polymers will be exemplified by the synthesis of alternating block copolymers ABABABA . . . , where A is a hydrophobic block, while B is a hydrophilic one. The examples describe the preparation of a (PSt-PEO)ₙ segmented copolymer and a PMMA-PEO-PMMA triblock copolymer with higher molecular weight PEO segments. In the later case the first formed ABA block copolymer could also be driven to higher molecular weight by coupling procedures described in other examples.

a. Synthesis of Degradable Alternating Block Polymers by ATRC

A PEG-based macroinitiator was synthesized using DCC-catalyzed procedure as described in incorporated references. Molecular weight of this macroinitiator (determined using PST as standard) was 4870 g/mol. The macroinitiator was used in ATRP of styrene. Thus, when the reaction was run at the following conditions: ST/CuBr/CuBr₂/BrPEG₄₈₇₀Br/PMDETA=100/1/0.05/1/1.05; T=80° C. The monomer conversion after 2.5 h was 0.11, and the molecular weight of the triblock copolymer was about 7,000. The experiment was repeated and the reaction was held at 80° C. for a longer reaction time. The reaction showed a linear semilogarithmic kinetic plot, and a linear dependence of molecular weights upon conversion and higher molecular weight block copolymers were prepared.

Coupling reactions conducted on these block copolymers showed further increase in molecular weight providing segmented hydrophilic/hydrophobic copolymers with degradable segments along the chain.

b. Synthesis of PMMA-PEO-PMMA Copolymers.

A PEO macroinitiator (MWV˜37,000) was prepared by taking purchased dihydroxy-PEO (MW 36,000) and making it into a difunctional macroinitiator. The macroinitiator was chain extended in both directions using MMA under standard ATRP conditions; in the synthesis of the triblock copolymer, the following ratios of components were used: Br—PEG_{36,000}-Br/MMA/CuBr/CuBr₂/PMDETA=0.5/400/1/0.05/1

The goal was to first measure the kinetics of the reaction, then run a large sample, and remove portions at given intervals to yield 10, 20, and 40% conversion (about 1,720, 6,880, and 13,760 MW MMA on each side). In the initial experiment the Mn went from 37,800 to 82,000 in 5 hours. This means that there are blocks of MMA of 22,100 on each side of the PEO. This polymer appears white, solid, and slightly sticky. This was repeated with the reaction being terminated after 3.5 hours to try to make shorter segments [DJS-071]. After this time, the Mn was 59,000, meaning that there MMA segments are each about 10,600 on each side (by GPC). This polymer was a little bit stickier than the higher MW sample. A third example was conducted, this time using slightly more PEO and a time calculated to produce segments of ˜2,000 on each side [DJS-075]. The result is a polymer with a total Mn of 55,000 with blocks of PMMA₄₀₀₀-PEO₃₇₀₀₀-PMMA₄₀₀₀.

### 15. Incorporation of Degradable Functionality into the Polymer During a Chain Extension Copolymerization

Using the procedures described in the examples above α-hydroxy-ω-bromo-polystyrene was initially prepared then the molecule was coupled forming an α,ω-di-hydroxypolystyrene which can be reacted with a macro-diacid or a diacid chloride in a condensation polymerization forming a polystyrene with distributed ester links. The reverse approach can also be followed.

a. Synthesis and Characterization of Br-Polyester-Br (Br-PE-Br)

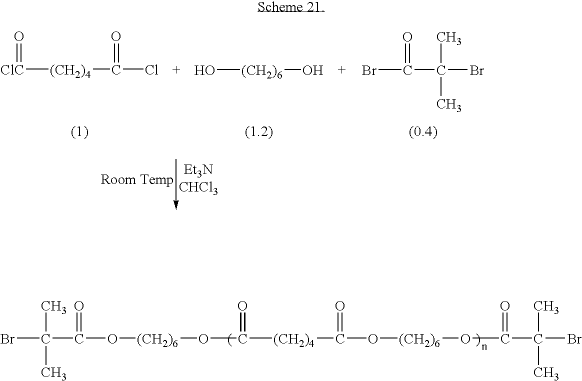

A polyester with number average molecular weight of 4600 and a PDI of 1.5 was obtained by adding the reaction mixture to methanol.

b. Synthesis and Characterization of a Copolymer Formed by ATRP Chain Extension of 15a to form Br-PS-P-PS-Br

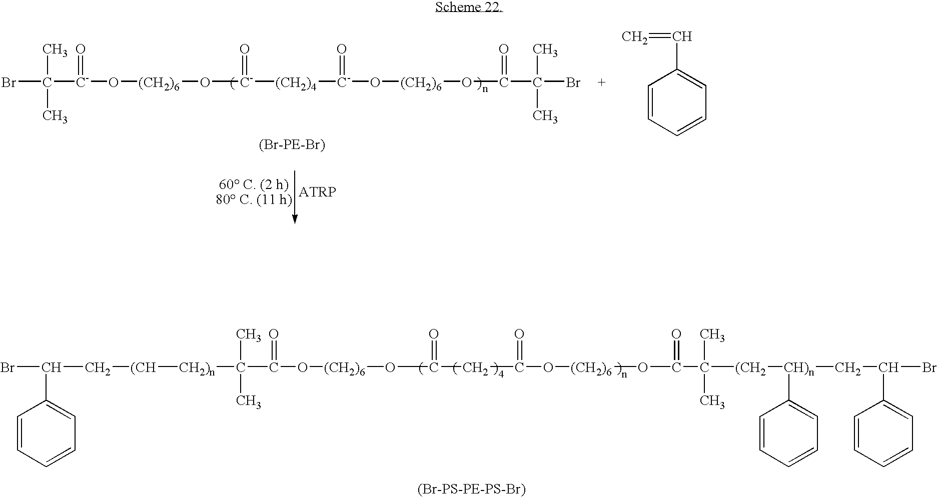

c. Synthesis of Segmented (PS-PE), by Coupling Reaction of Polymer 15b.

The molecular weight increases three fold after coupling of Br—PS-PE-Br having Mₙ=30,000 with the final polymer having a Mₙ=93,000.

d. The degradable copolymers prepared in the earlier examples can also be incorporated into coupling reactions. The first degradable copolymer can be the sole polymer that is chain extended or can be one or two or more copolymers that can be chain extended. In each case, the degradability of the first copolymer can be enhanced by the second degradable functionality incorporated in the chain coupling reaction.

Many modifications and other embodiments of the invention will come to mind to one skilled in the art to which this invention pertains having the benefit of the teachings presented in the foregoing descriptions and the associated tables. Therefore, it is to be understood that the invention is not to be limited to the specific compositions, components or process steps, as such embodiments disclosed may vary and that modifications and other embodiments are intended to be included within the scope of the appended claims. Although specific terms are employed herein, they are used in a generic and descriptive sense only and not for purposes of limitation. It must be noted that, as used in this specification and the appended claims, the singular forms “a,” “and,” and “the” include plural referents unless the context clearly dictates otherwise. Thus, for example, reference to “a polymer” includes one or more polymers, reference to “a substituent” includes one or more substituents, and the like.

We claim the processes described and materials disclosed herein including:

1. A polymer, comprising:
a polymer backbone, comprising:
two or more polymer segments comprising radically (co)polymerizable vinyl monomer units; and
one or more degradable units independently selected from hydrodegradable, photodegradable and biodegradable units between the polymer segments and dispersed along the polymer backbone.

2. The polymer of claim 1, wherein the polymer has a molecular weight distribution of less than 2.0.

3. The polymer of claim 1, wherein one or more of the degradable units is derived from one or more monomers comprising a heterocyclic ring that is capable of undergoing radical ring opening polymerization.

4. The polymer of claim 3, wherein the one or more monomers comprising a heterocyclic ring comprises one or more atoms selected from oxygen atoms, nitrogen atoms, sulfur atoms or combinations thereof.

5. The polymer of claim 1, wherein one or more degradable units comprise dithio groups.

6. The polymer of claim 1, wherein the polymer is capable of degrading by at least one of a hydrodegradation, photodegradation or biodegradation mechanisms to form at least one of telechelic oligomer and telechelic polymeric fragments of the polymer.

7. The polymer of claim 1, wherein the polymer is capable of degrading by at least two of hydrodegradation, photodegradation or biodegradation mechanisms to form at least one of telechelic oligomers and telechelic polymeric fragments of the polymer.

8. The polymer of claim 1, wherein the polymer backbone comprises two different degradable units.

9. The polymer of claim 8, wherein the polymer is capable of degrading into telechelic oligomer and telechelic polymer fragments comprising at least one of hydroxy, carboxy, amino, amide, and thio end groups, wherein the polymer fragments have a molecular weight distribution of less than 5.0.

10. The polymer of claim 9, wherein the wherein at least a portion of the telechelic oligomer and telechelic polymeric fragments are homo-telechelic materials.

11. The polymer of claim 9, wherein the wherein at least a portion of the telechelic oligomer and telechelic polymeric fragments are hetero-telechelic materials.

12. The polymer of claim 9, wherein the molecular weight distribution of the polymer fragments is less than 3.0.

13. The polymer of claim 9, wherein the molecular weight distribution of the polymer fragments is less than 2.5.

14. The polymer of claim 9, wherein the average molecular weight of the polymer fragments is less than the renal threshold.

15. The polymer of claim 1, wherein the degradable unit comprises at least one group selected from an α-ketoester group, an anhydride, a sulfide, an amide, ether, ester, ketone, carbamate, acids, thio, dithio, and combinations thereof.

16. The polymer of claim 1, wherein the degradable units are randomly distributed along the polymer backbone.

17. The polymer of claim 1, wherein the degradable units are periodically distributed along the polymer backbone.

18. The polymer of claim 1, wherein the polymer is a block copolymer comprising two or more blocks.

19. The polymer of claim 18, wherein two or more of the blocks comprise one or more degradable units.

20. The polymer of claim 19, wherein the degradable functionality is a photodegradable functionality, a hydrolytically degradable functionality or a bio-degradable functionality.

21. The polymer of claim 1, wherein the level of incorporation of degradable functionality can be selected by determining the ratio of comonomers comprising degradable functionality and stable monomer units incorporated into the copolymer and the final molecular weight of the copolymer.

22. The copolymer of claim 21, wherein the final molecular weight of the copolymer can be selected by the ratio of added initiator to final (co)monomer conversion.

23. The copolymer of claim 22, wherein the molecular weight of the degraded polymer fragments are a direct result of the level of monomer units comprising the degradable functionality incorporated into to the copolymer and the final copolymer molecular weight.

24. A copolymer, comprising a polymer backbone capable of being degraded into two or more fragments selected from telechelic oligomers and telechelic polymers.

25. The copolymers of claim 24, wherein the polymer backbone comprises degradable functionality and an end group of the telechelic oligomers and telechelic polymers is a residue of the degradable functionality.

26. The copolymers of claim 24, wherein the molecular weight distribution of the fragments is less than 3.0.

27. The copolymers of claim 24, wherein the molecular weight distribution of the fragments is less than 2.5.

28. A copolymer, comprising one or more monomer units derived from captodative monomers

29. A copolymerization processes, comprising:
copolymerizing heterocyclic monomers by radical ring opening polymerization and radically polymerizable monomers by a controlled polymerization process, thereby forming a polymer comprising a polymer backbone comprising the heterocyclic monomers and the radically polymerizable monomers.

30. The copolymerization process of claim 29, wherein the heterocyclic monomer units are randomly distributed along the backbone of the copolymer.

31. A degradable polymer, comprising:
alkyl(meth)acrylate monomer units.

32. The degradable polymer of claim 31, further comprising:
functional groups.

33. A degradable polymer, comprising:
alkyl(meth)acrylamide monomer units.

34. The degradable polymer of claim 33, further comprising:
functional groups.

35. A degradable polystyrene, comprising:
styrene monomer units; and
degradable units, wherein the degradable polystyrene is capable of degrading into at least one of telechelic oligomer fragments and polymer fragments by hydrolytic and photolytic degradation.

36. A degradable polyethylene copolymer, comprising:
ethylene monomer units; and
degradable units, wherein the degradable polyethylene copolymer is capable of degrading into at least one of telechelic oligomer fragments and polymer fragments by hydrolytic and photolytic degradation.

37. The degradable polyethylene of claim 36, wherein the degradable units comprises a ring opening polymerizable monomer.

38. A degradable terpolymer, comprising:
a polymer backbone, comprising:
two or more radically (co)polymerizable monomers; and
at least one ring opening polymerizable monomer unit comprising a hydrolytically or pholtolytically degradable group.

39. A copolymer, comprising:
a styrene based monomer; and
2-oxo-3-methylene-5-phenyl-1,4-dioxane monomer.

40. A degradable copolymer, comprising:
radically polymerizable monomer units; and
biocompatible segments formed by a ring opening polymerization process.

41. The degradable copolymer of claim 40, further comprising polyethylene oxide monomer units.

42. A copolymer, comprising functional units attached to a polymer backbone by a degradable functionality, wherein the degradable functionality comprises radical ring opening addition polymerizable monomers.

43. A branched copolymer, comprising:
a backbone, and
branches, wherein the branches are attached to the polymer backbone by degradable functionality.

44. A star copolymer, comprising:
a star core comprising degradable functionality, and
branches attached to the star core.

45. A copolymer network, comprising:
crosslinking groups, wherein the crosslinking groups comprise degradable functionality.

46. The polymer of claim 1, wherein the polymer backbone is capable of degrading into polymer fragments having a molecular weight distribution of less than 5.0.

47. The polymer of claim 46, wherein the polymer fragments have a molecular weight distribution of less than 3.0.

48. A method of producing a degradable polymer, comprising:
coupling two or more polymers comprising a radically transferable atom or group with a linking compound comprising one or more degradable units selected from hydrodegradable, photodegradable, and biodegradable units.

49. The method of claim 48, wherein the linking compound further comprises two or more radically polymerizable atoms or groups.

50. The method of claim 48, wherein the degradable unit is at least one group selected from ester, ether, ketone, amide, carbamate, acids, anhydride, sulfide, thio, and dithio groups.

51. A method of producing a degradable polymer, comprising:
polymerizing radically polymerizable monomers with an initiator comprising a degradable unit selected from hydrodegradable, photodegradable, and biodegradable units and at least two radically transferable atoms or groups in an atom transfer radical polymerization process.

52. The method of claim 51, wherein the degradable unit is at least one group selected from ester, ether, ketone, amide, carbamate, acids, anhydride, sulfide, thio, and dithio groups.

53. The method of claim 51, further comprising:
exposing the degradable polymer to a metal in metal in its zero oxidation state to form a polymer with degradable functionality dispersed along the chain.
